(19) United States
(12) Patent Application Publication
(10) Pub. No.: US 2004/0252340 A1
(43) Pub. Date: Dec. 16, 2004

(54) Image processing system, image processing method, template producing system and template data structure

(75) Inventors: Katsumi Komagamine, Nagano (JP); Tatsuro Oshikawa, Nagano (JP); Minoru Ichimura, Nagano (JP); Hidekazu Mori, Nagano (JP); Hideyuki Narusawa, Nagano (JP); Yoichi Tanaka, Nagano (JP); Hidetake Nishizawa, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/803,886

(22) Filed: Mar. 19, 2004

Related U.S. Application Data
(63) Continuation-in-part of application No. 10/263,346, filed on Oct. 3, 2002.

(30) Foreign Application Priority Data
Oct. 3, 2001 (JP) P.2001-307947
Jul. 24, 2002 (JP) P.2002-215831
Mar. 20, 2003 (JP) P.2003-077688
Jun. 10, 2003 (JP) P.2003-164889
Aug. 19, 2003 (JP) P.2003-295034
Mar. 1, 2004 (JP) P.2004-056346

(51) Int. Cl. G06K 15/02; H04N 1/387; H04N 1/393

(52) U.S. Cl. 358/1.18; 358/1.2; 358/450; 358/451

(57) ABSTRACT

An image processing system, includes an operating unit, which select a first size of a reproducing medium, a size information acquiring unit, which acquires size information related to a template for defining a layout of an object, the size information indicating a second size of a reproducing medium, and a print control unit, which outputs an instruction for printing a predetermined object on the reproducing medium having the first size in accordance with the template. The first size is different from the second size indicated by the size information related to the template. The aspect ratio of the reproducing medium having the first size is equal to, or approximates to that of the reproducing medium having the second size.

### BACKGROUND OF THE INVENTION

The present invention is related to an image processing system for printing an object such as digital photographic image, and the like based on template data. Also, the present invention is related to a data structure of the template data for defining a reproducing format of the object such as digital photographic image, and the like.

Recently, automatic editing methods are known in the technical field, by which template data for defining layouts of objects are automatically edited in connection with changes of these objects, and changes in sizes of reproducing media (see, for example, JP-A-11-219440).

In accordance with the publication described in JP-A-11-219440, however, there is a problem that layouts of entire reproducing areas are converted into such layouts which are not analogous to original layouts due to editing of the original template since margins are set in completely different manners in connection with changes of reproducing areas. For example, when an aspect ratio (namely, ratio of longitudinal length to lateral length) of a reproducing area is changed, a layout in which a photograph is disposed on the reproducing area in a full size without any margin is converted into such a layout that the photograph is disposed on a portion of the reproducing area by leaving a margin. Also, when an aspect ratio of a reproducing area is changed, a layout in which a photograph is disposed on the reproducing area by leaving a margin having a constant width on a peripheral edge of the reproducing area is converted into such a layout that the photograph is disposed on the reproducing area by leaving margins whose widths are not constant on the peripheral edge of the reproducing area.

The above-described problem may be solved by preparing template data with respect to each of sizes as to reproducing media. However, in such a case that the template data are prepared with respect to each of the sizes as to the reproducing media, there is another problem that a total template data amount is increased in correspondence with a total number of template data.

### SUMMARY OF THE INVENTION

An object of the present invention is to reduce a total data amount of template data which are required to reproduce objects in analogous layouts with respect to reproducing media having a large number of sizes.

In order to achieve the above object, according to the present invention, there is provided an image processing system, comprising:

an operating unit, which select a first size of a reproducing medium;

a size information acquiring unit, which acquires size information related to a template for defining a layout of an object, the size information indicating a second size of a reproducing medium; and

a print control unit, which outputs an instruction for printing a predetermined object on the reproducing medium having the first size in accordance with the template,

wherein the first size is different from the second size indicated by the size information related to the template; and

wherein the aspect ratio of the reproducing medium having the first size is equal to, or approximates to that of the reproducing medium having the second size.

In the above image processing system according to the present invention, a total data amount of template data which are required to reproduce objects in analogous layouts with respect to reproducing media having a large number of sizes can be reduced.

Furthermore, the image processing system, according to the present invention, further comprises comprising a restriction information acquiring unit, which acquires restriction information for restricting available sizes of the reproducing mediums on which the object can be printed in accordance with the template. The print control unit outputs the instruction for printing the predetermined object on the reproducing medium having the first size in accordance with the template which is adapted to the restriction information.

Since the size of the reproducing medium is restricted based upon the restriction information related to the template, it can avoid that the reproduction image quality is considerably deteriorated. Also, since the restriction information related to the template is utilized, the size of the reproducing medium can be restricted in correspondence with restrictions made by copyright.

Furthermore, in the image processing system according to the present invention, the restriction information restricts a maximum size of the reproducing medium on which the object can be printed in accordance with the template.

Furthermore, in the image processing system according to the present invention, the restriction information restricts a range of aspect ratios of the reproducing medium on which the object can be printed in accordance with the template.

Furthermore, the image processing system according to the present invention, further comprises comprising a selecting unit, which selects the template related to the size information indicating the reproducing medium having the second size, the aspect ratio of which is equal to, or approximates to that of the reproducing medium having the first size from a plurality of the templates. The print control unit outputs the instruction for printing the predetermined object on the producing medium having the first size in accordance with the selected template.

According to the present invention, there is also provided an image processing method, comprising the steps of:

selecting a first size of a reproducing medium;

acquiring size information related to a template for defining a layout of an object, the size information indicating a second size of a reproducing medium; and

outputting an instruction for printing a predetermined object on the reproducing medium having the first size in accordance with the template,

wherein the first size is different from the second size indicated by the size information related to the template; and

wherein the aspect ratio of the reproducing medium having the first size is equal to, or approximates to that of the reproducing medium having the second size.

In the above image processing method according to the present invention, a total data amount of template data which are required to reproduce objects in analogous layouts with respect to reproducing media having a large number of sizes can be reduced.

According to the present invention, there is also provided a template producing system, comprising:

a generating unit, which generates a template for defining a layout of an object, the template related to size information which indicates a size of a reproducing medium;

a restriction information setting unit, which sets restriction information for restricting available sizes of the reproducing mediums on which the object can be printed in accordance with the template in relation to the template; and

an output unit, which outputs both the generated template and the set restriction information.

In the above template producing system according to the present invention, a total data amount of template data which are required to reproduce objects in analogous layouts with respect to reproducing media having a large number of sizes can be reduced.

To achieve the above object, a template data structure, according to the present invention, comprises a plurality of template data which defines reproducing formats, the reproducing formats being analogous to each other, and having different sizes to each other; and index data which defines a relation ship between each of the template data and a size of a reproducing medium on which the object can be printed by employing each of the template data, in which the above-described template data are related to the above-explained index data with each other. Since a reproducing format is defined by each of the template data while a reproducing medium having a predetermined size is employed as a reference, as to such reproducing media whose aspect ratios are not made coincident with each other, or are not analogous to each other, reproducing formats can be defined based upon different coordinates. Since the size of the reproducing medium capable of reproducing the object every template data is defined by employing each of these template data, as to such reproducing media whose aspect ratios are made coincident with, or are analogous to each other, the reproducing format can be defined by one piece of the template data. Also, since reproduceable sizes are defined every template data in response to a design of a reproducing format, the number of template data can be optimized.

Concretely speaking, for instance, in the case of such a reproducing format having a margin at a peripheral area thereof, when an object is reproduced on a reproducing medium, both the size and the aspect of which are different from those of the reference of this reproducing format, by enlarging one piece of the template data, a dimensional relationship between widths of right/left margins and widths of upper/lower margins is changed from the original design of the first-mentioned reproducing format. In this case, if a reproducing format owns such a design whose margin is sufficiently large, even when a dimensional relationship between widths of right/left margins and widths of upper/lower margins is changed from the original design of the reproducing format, then a peripheral portion of the object is not cut off. As a result, even when the object is reproduced on reproducing media having a plurality of sizes by employing one piece of the template data, a variation in designs is small. On the other hand, if a reproducing format owns a design having no margin, then a peripheral portion of the object is cut off, and also, a margin is newly formed at a portion where the margin is not originally formed. As a result, when the object is reproduced to the reproducing media having the plural sizes by employing one piece of the template data, a variation in designs is large. As a consequence, since the reproduceable sizes are defined every template data in response to the designs of the reproducing formats, the number of these template data can be optimized in response to these events which may depend upon the designs of the reproducing formats.

Furthermore, a template data structure, according to the present invention, is featured by that both the plurality of template data and the index data have been stored in one file. Since the plural template data and the index data are stored in one file, portability of both the template data and the index data may be improved.

Moreover, a template data structure, according to the present invention, is featured by that the template data contains a parameter for indicating as to whether or not the object can be reproduced by using the template data on a reproducing medium having a size other than such sizes which are used as the references of the reproducing formats defined by the template data. Since such a parameter for indicating as to whether or not the object can be reproduced by using the template data on the reproducing medium having the size other than such sizes which are used as the references of the reproducing formats defined by the template data is contained in the template data, even in such a case that the object is reproduced only by employing the template data without referring to the index data, the application range of the template data can be limited.

In addition, a template data structure, according to the present invention, is featured by that the template data contains a parameter for defining a maximum size of a reproducing medium which can be reproduced by employing the template data. Since such a parameter for defining the maximum size of the reproducing medium which can be reproduced by employing the template data is contained in the template data, even in such a case that the object is reproduced only by employing the template data without referring to the index data, the application range of the template data can be limited.

To achieve the above-explained object, a template data structure, according to the present invention, is featured by that in a plurality of template data for defining reproducing formats of an object, which are analogous to each other, a template data structure is comprised of: a plurality of template data for defining the reproducing formats, while reproducing media having predetermined sizes are employed as references respectively; and index data for defining an aspect ratio of a reproducing medium capable of reproducing the object every the template data by employing each of the plural template data. Since the reproducing format is defined by each of the template data while the reproducing medium having a predetermined size is employed as the reference, as to such reproducing media whose aspect ratios are not made coincident with each other, or are not analogous to each other, reproducing formats can be defined based upon different coordinates. Since the aspect ratio of the reproducing medium capable of reproducing the object every the template data is defined by employing each of these template data, as to such reproducing media whose aspect ratios are made coincident with, or are analogous to each other, a reproducing format can be defined by one piece of the template data. Also, since reproduceable aspect ratios are defined every template data in response to a design of a reproducing format, the number of template data can be optimized.

Furthermore, a template data structure, according to the present invention, is featured by that both the plurality of template data and the index data have been stored in one file. Since the plural template data and the index data are stored in one file, portability of both the template data and the index data may be improved.

Moreover, a template data structure, according to the present invention, is featured by that the index data contains a parameter for indicating as to whether or not the object can be reproduced by using the template data on a reproducing medium having a size other than such sizes which are used as the references of the reproducing formats defined by the template data every the template. Since such a parameter for indicating as to whether or not the object can be reproduced by using the template data on the reproducing medium having the size other than such sizes which are used as the references of the reproducing formats defined by the template data is contained in the index data in addition to the aspect ratio of the reproduceable reproducing medium, an application range of the template data can be limited. Also, such a template data fitted to a preselected reproducing medium can be specified by merely referring to the index data, while does not refer to the template data.

In addition, a template data structure, according to the present invention, is featured by that the index data contains a parameter for defining a maximum size of a reproducing medium which can be reproduced by employing the template data every the template. Since the parameter for defining the maximum size of the reproducing medium which can be reproduced by employing the template data every template data is contained in the index data in addition to the aspect ratio of the reproducing medium on which the object can be reproduced by using the respective template data, as to such reproducing media whose aspect ratios are made coincident with, or are analogous to each other, but whose sizes are largely different from each other, the template data are individually prepared, and, for instance, resolution of an image indicative of a background image can be changed every template in response to a size of a reproducing medium.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a schematic diagram for showing a template data structure according to the first embodiment of the present invention;

FIG. 2 is a block diagram for indicating an arrangement of a printer related to the first embodiment of the present invention;

FIG. 3 is a perspective view for indicating an arrangement of a printer related to the first embodiment of the present invention;

FIG. 4 is a transition diagram for indicating an arrangement of a printer related to the first embodiment of the present invention;

FIG. 5 is a transition diagram for indicating an arrangement of a printer related to the first embodiment of the present invention;

FIG. 6 is a schematic diagram related to the first embodiment of the present invention;

FIG. 7 is a schematic diagram related to the first embodiment of the present invention;

FIG. 8 is a schematic diagram related to the first embodiment of the present invention;

FIG. 9 is a schematic diagram related to the first embodiment of the present invention;

FIG. 10 is a schematic diagram related to the first embodiment of the present invention;

FIG. 11 is a schematic diagram related to a comparison example of the present invention;

FIG. 12 is a data flow diagram related to the first embodiment of the present invention;

FIG. 13 is a schematic diagram related to the first embodiment of the present invention;

FIG. 14 is a data flow diagram related to the first embodiment of the present invention;

FIG. 15 is a schematic diagram related to the first embodiment of the present invention;

FIG. 16 is a schematic diagram for showing a template data structure according to a second embodiment of the present invention;

FIG. 17 is a flow chart related to the second embodiment of the present invention;

FIG. 18 is a block diagram for indicating an arrangement of a printer related to a third embodiment of the present invention;

FIG. 19 is a flow chart related to the third embodiment of the present invention;

FIG. 20 is a schematic diagram showing a screen according to the third embodiment of the present invention;

FIG. 21 is a schematic diagram showing a screen according to the third embodiment of the present invention;

FIG. 22 is a diagram showing the external appearance of a printer according to the fourth embodiment of the invention;

FIG. 23 is a block diagram of a hardware configuration of the printer shown in FIG. 22;

FIG. 24 is a diagram illustrating a data structure in a memory card shown in FIG. 22;

FIG. 25 is a diagram illustrating an example of contents of a print-condition setting script stored in the memory card;

FIG. 26 is a diagram illustrating an example of a user interface of the printer;

FIG. 27 is a flowchart explanatory of processing performed when the memory card is attached to the printer;

FIG. 28 is a diagram illustrating an example of the user interface;

FIG. 29 is a flowchart explanatory of the display/selection processing performed in the user interface;

FIG. 30 is a flowchart explanatory of processing when a layout selection is performed;

FIG. 31 is a diagram illustrating an example of the user interface; and

FIGS. 32A to 32D are diagrams explanatory of the operation of the printer.

### DETAILED DESCRIPTION OF THE PREFERRED EMBODIMENTS

Various embodiments of the present invention will now be described below.

(First Embodiment)

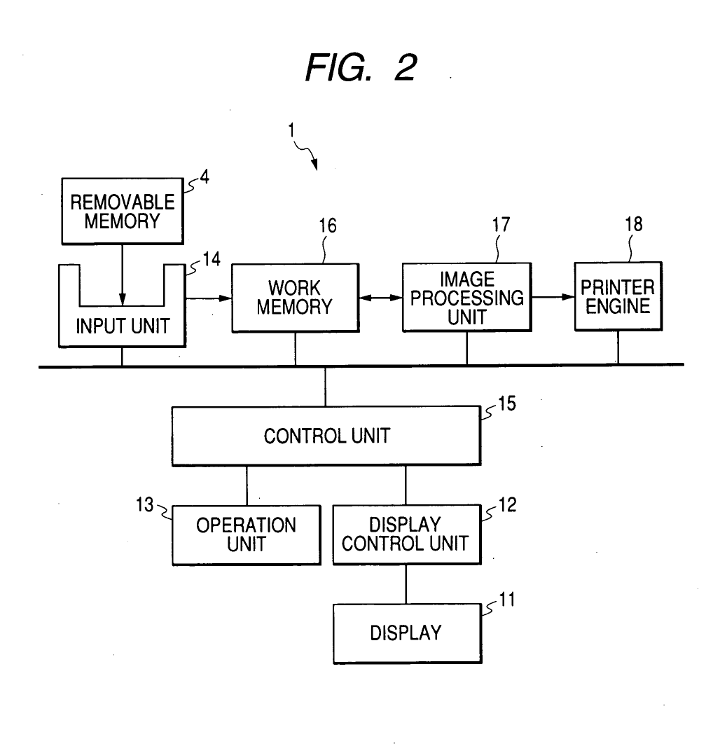

FIG. 2 is a block diagram showing a printer 1 according to the present invention. The printer 1 corresponds to a so-called “stand-alone type printer”. A display 11 is constituted by an LCD, or the like. A display control unit 12 is equipped with a VRAM, a drive circuit, and the like. An operation unit 13 has a plurality of switches such as a jog key, a print starting key, and the like. The operation unit 13 accepts selecting operations as to sizes of printing papers served as reproducing media, selecting operations as to basic designs of templates, a starting operation of printing operation, a stop operation of printing operation, and the like.

While an input unit 14 is controlled by a control unit 15, the input unit 14 reads a kind of data such as an image file, a reference template and index data stored in the removable memory 4, and then stores the read data into a work memory 16. The removable memory 4 corresponds to a detachable recording medium with respect to the input unit 14. The removable memory 4 corresponds to, for instance, a card type IC memory which is detachably mounted on a digital camera. The input unit 14 is served as a size information acquiring unit and a restriction information acquiring unit.

The control unit 15 includes a CPU and a ROM (which are not shown). The control unit 15 is served as the operation unit, the size information acquiring unit and the restriction information acquiring unit and a print control unit. The CPU executes a program which is stored in the ROM so as to control an entire operation of the printer 1. The program contains a resizing process operation of a template. The resizing process operation is a process operation that a print template corresponding to a printing paper size set by a user is produced from a reference template which is previously stored, and then, the produced print template is stored in the work memory 16. A detailed content of this resize processing operation will be described in detail. The control unit 15 produces printing object image data based upon both an image file and a print template which are stored in the work memory 16, and then stores the produced printing object image data into the work memory 16. These programs and various sorts of data such as reference templates may be alternatively downloaded via a network from a predetermined server, or may be alternatively read from a computer-readable recording medium such as a removable memory, and thereafter, the read program and data may be entered.

An image processing unit 17 corresponds to an ASIC which executes a process operation for converting the printing object image data stored in the work memory 16 into image data in conjunction with the control unit 15. It should also be noted that a decision for determining as to whether a processing operation for converting printing object image data into print data is carried out by the control unit 15, or the image processing unit 17 is a choice of design. Concretely speaking, in the image processing unit 17, for example, a changing process operation of a color space, a resolution converting process operation, a half-tone processing operation, an interlacing process operation, and the like are carried out with respect to the printing object image data stored in the work memory 16 so as to produce print data.

A printer engine 18 is controlled by the control unit 15 so as to print an image on a printing paper based on the print data produced in the image processing unit 17. The printer engine 18 forms images on printing papers by way of, for example, an ink jet system, a laser system, a sublimation type thermal transfer system, a dot impact system, and the like.

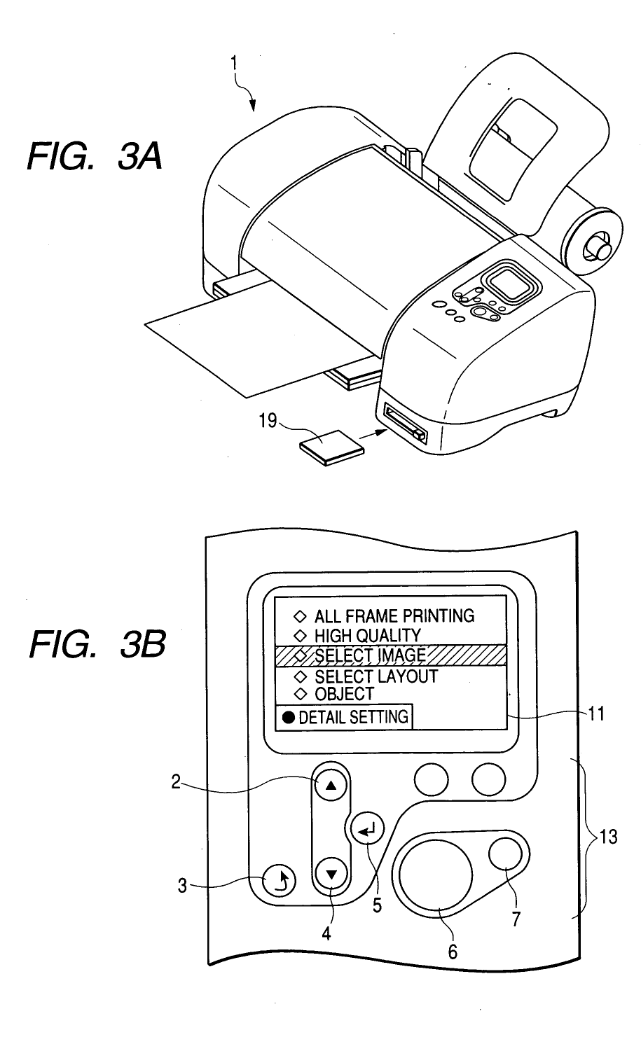

FIG. 3A is a perspective view showing an outer appearance of the printer 1. FIG. 3B is a diagram showing the display 11 and the operation unit 13 of the printer 1 in an enlarging manner. A plurality of switches are provided on the operation unit 13, and these switches are an up switch 2, a down switch 4, a decision switch 5, a back switch 6, a print switch 6, a stop switch 7, and the like. A menu for setting a plurality of items is displayed on the display 11. The up switch 2, the down switch 4, the decision switch 5, and the back switch 6 correspond to switches used to select items of the menu. The print switch 6 corresponds to a switch used to instruct starting of a printing operation. The stop switch 7 corresponds to a switch used to instruct an interrupt of a printing operation.

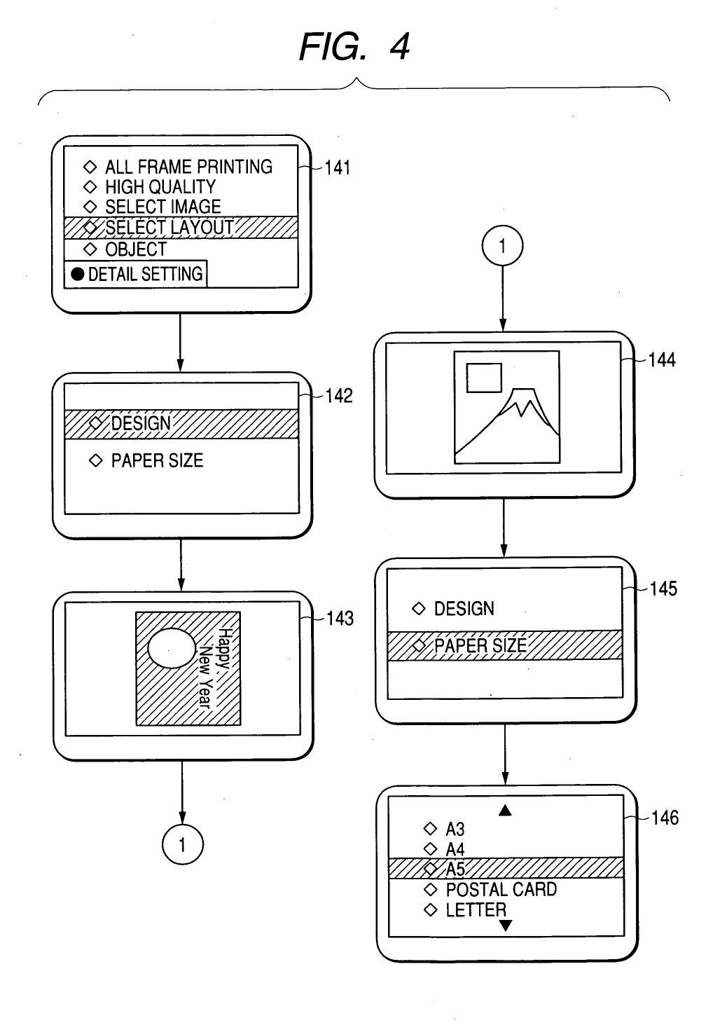

FIG. 4 is a transition diagram as to screens which are displayed on the display 11 in a mode for selecting a reproducing format. When “layout print” is selected on a screen 141 by manipulating the up switch 2, the down switch 4, and the decision switch 5, such a screen 142 containing “design” and “paper size” is displayed, while “design” is to be moved to a menu for selecting a reference template package, and “paper size” is to be moved to a menu for selecting a paper size. A detailed content of this reference template package will be described later. When “design” is selected on the screen 142, this screen 142 is moved to a screen 143 and another screen 144, on which any of the reference template packages previously stored in the ROM 8 is selectable. When the up switch 2, the down switch 4, and the decision switch 5 are depressed under such a condition that the screen 143 and the screen 144 are displayed, and thus, any of the reference template packages is selected, these screens 143 and 144 are returned to the screen 142. When “paper size” is selected on the screen 142, another screen 146 which contains a list of paper sizes as a selection subject item is displayed. On this screen 146, a paper size can be set by depressing the up switch 2, the down switch 4, and the decision switch 5.

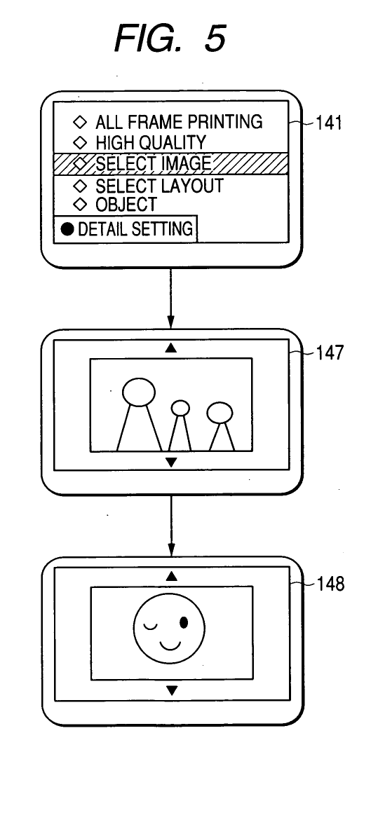

FIG. 5 is a transition diagram of a screen which is displayed on the display 11 in a mode used to select image data which is inserted into a print template. When “image select” is selected on the screen 141 by manipulating the up switch 2, the down switch 4, and the decision switch 5, the printer 1 displays either image data or a title of this image data which are read from the removable memory 19. On a screen 147 and another screen 148, which display thereon either the image data or the title thereof read from the removable memory 19, another image data stored in the removable memory 19 can be selected by depressing the up switch 2 and the down switch 4. When the decision switch 5 is depressed under such a condition that these screens 147 and 148 are displayed, the image data which is being displayed at this time is determined as image data which will be inserted into the print template.

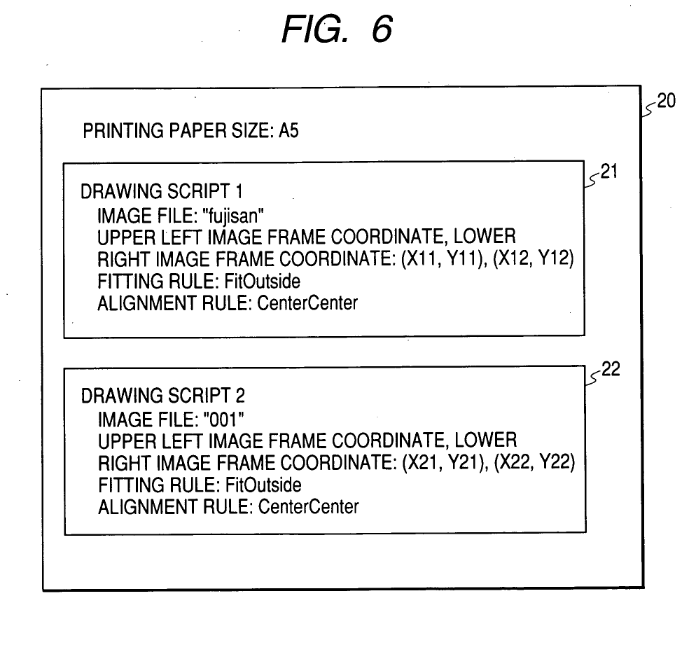

FIG. 6 is a schematic diagram showing a print template 20. In this print template 20, a drawing scripts 21, 22 and the like are recorded. These drawing scripts 21 and 22 define a layout as to objects such as printing paper sizes, images, and characters. The drawing script 21 is constructed of a path (for instance, “fujisan”) of a file as to an image to be printed, an image frame coordinate, a fitting rule (for example, “FitOutside”) for defining a positional relationship between an image and an image frame, an alignment rule (for instance, “CenterCenter”), and the like. The image frame coordinate (for example, upper left coordinate “(X11, Y11)”, lower right coordinate “(X12, Y12)”) indicates a location of an image on a printing paper. In a case that a plurality of images are arranged on one sheet of paper, drawing scripts are arrayed every image, and an upper/lower relationship of layers is defined in accordance with appearing sequences of the drawing scripts. An image file inserted into the print template corresponds to either an image (for example, “fujisan”) which is previously determined by a reference template, or an image file designated by a user. In the case of the latter image file, the user is prompted to select an image file (for example, image file “001”) which will be read in relation to an identifier (for instance, “photograph 1”) described in a reference template (will be explained later) by way of a menu displayed on a display 11 from photograph images which are stored in the removable memory 4.

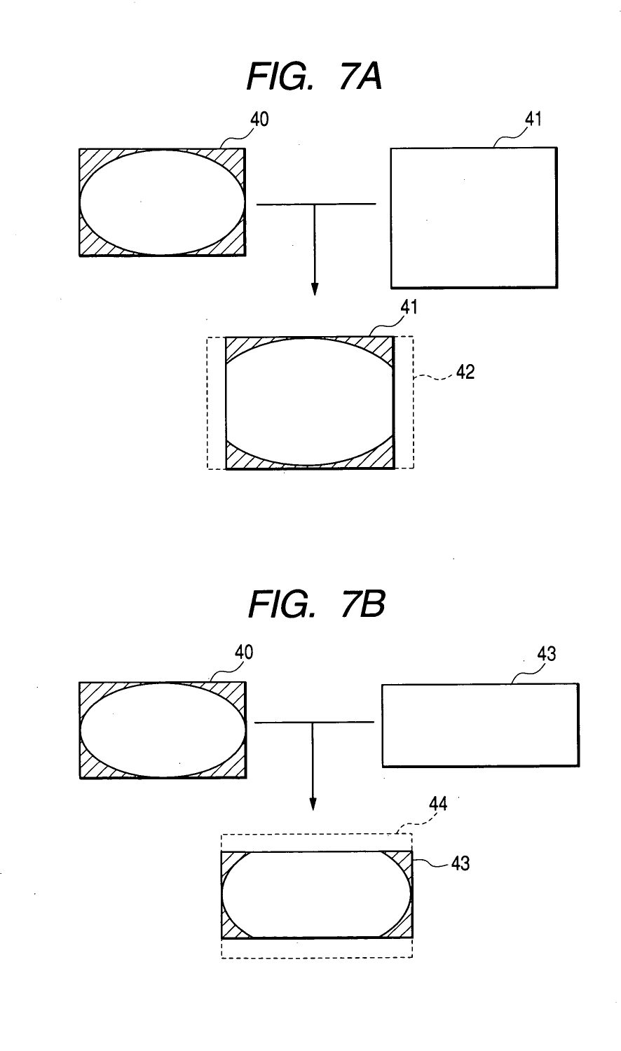

FIG. 7 is a schematic diagram for explaining the fitting rule of “FitOutside”. The “FitOutside” corresponds to a parameter which indicates that when an image is inserted into an image frame whose aspect ratio is different from an aspect ratio of the image, the image is clipped without changing the aspect ratio of the image in such a manner that at least one set of two edges is overlapped with the image frame among two sets of two edges of this image, which are located opposite to each other. As shown in FIG. 7A, when an aspect ratio of an image frame 41 is larger than an aspect ratio of an image 40, the image 40 is enlarged, or compressed in such a manner that two edges of the image frame 41 and the image 40, which are located opposite to each other along a lateral direction, are overlapped with each other, and such an image 40 that an image portion thereof stuck out from the image frame 41 is clipped is inserted into the image frame 41. Also, as shown in FIG. 7B, when an aspect ratio of an image frame 43 is smaller than or equal to an aspect ratio of an image 40, the image 40 is enlarged, or compressed in such a manner that two edges of the image frame 43 and the image 40, which are located opposite to each other along a longitudinal direction, are overlapped with each other, and such an image 40 that an image portion thereof stuck out from the image frame 43 is clipped is inserted into the image frame 43. As previously explained, when the images are inserted into the image frames in accordance with the fitting rule “FitOutside”, either the upper/lower edges of the images or the right/left edges thereof are clipped, and then the clipped images are inserted into the entire image frames without margin within the image frames.

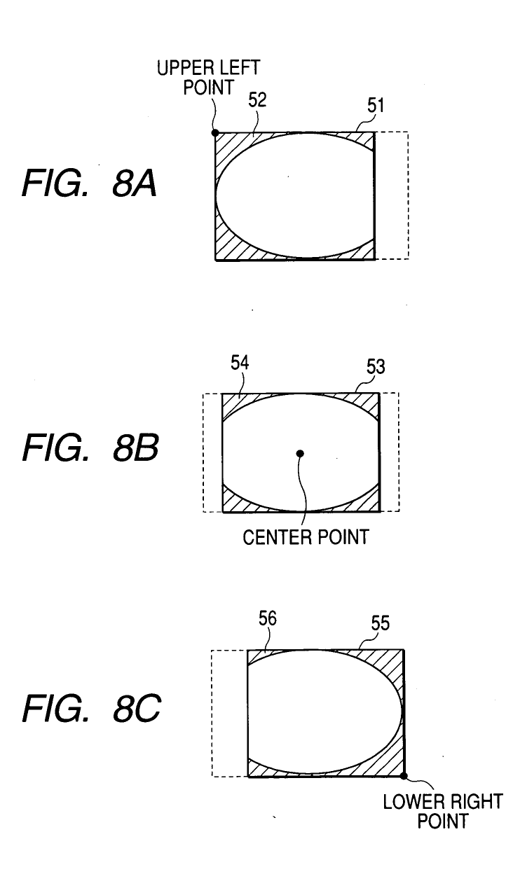

FIG. 8 is a schematic diagram for explaining an alignment rule. An alignment rule corresponds to a parameter for determining an arrangement of an image and an image frame, and for defining an alignment reference as to a lateral direction and a longitudinal direction. In the case that the alignment rule is “LeftTop”, as indicated in FIG. 8A, an image 52 is inserted in such a manner that an upper left point of an image frame 51 is overlapped with an upper left point of the image 52. In the case that the alignment rule is “CenterCenter”, as indicated in FIG. 8B, an image 54 is inserted in such a manner that a center point of an image frame 53 is overlapped with a center point of the image 54. In the case that the alignment rule is “RightBottom”, as indicated in FIG. 8C, an image 56 is inserted in such a manner that a lower right point of an image frame 55 is overlapped with a lower right point of the image 56.

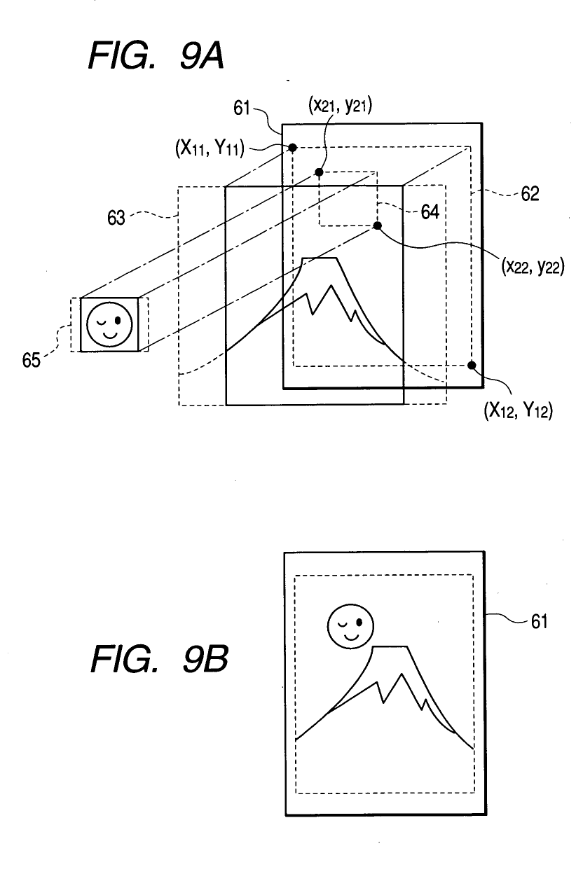

FIG. 9A is a schematic diagram for explaining a production of printing object image data. The printing object image data is produced based upon both a print template 20, image data which is previously defined by the reference template and image data which is selected by the user. In other words, the printing object image data is produced in such a manner that an image 63 and another image 65 are inserted into an image frame 62 and another image frame 64 which are defined by the print template 20, in accordance with both the fitting rule and the alignment rule. FIG. 9B is a schematic diagram for indicating a result that the printing object image data is printed on a paper 61.

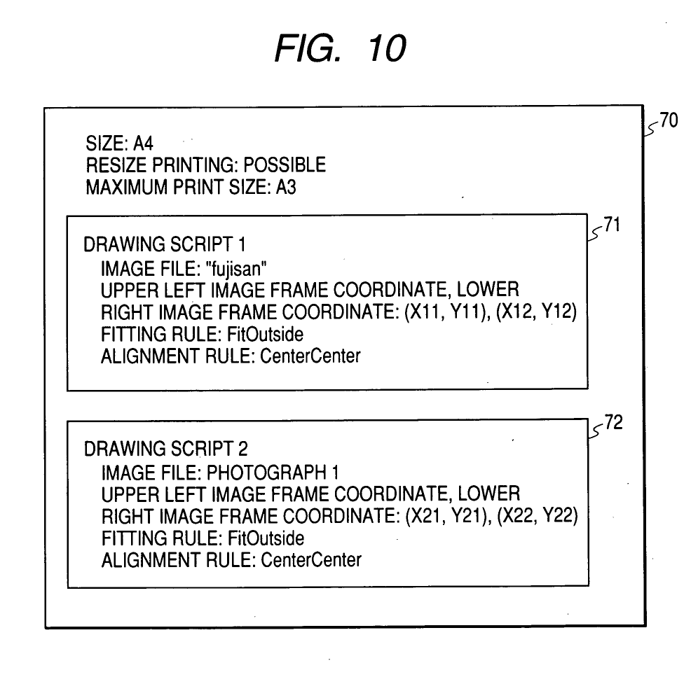

FIG. 10 is a schematic diagram showing a reference template 70. Similar to the print template 20, paper sizes served as size information, drawing scripts 71, 72, and the like is written in this reference template 70. In a case that an image file which is inserted into the print template is previously determined, a file name (for example, “fujisan”) of this image file is described in the drawing script. In such a case that an image file is designated by a user, an identifier (for instance, “photograph 1”) is described in the drawing script. This identifier is employed so as to relate an image frame to an image file by the printer 1. Also, a mark for indicating whether or not a resizing operation is allowed, and a maximum printing size which are served as the restriction information is written into the reference template 70. The mark for indicating whether or not the resizing operation shows whether or not a print template of another printing paper size can be produced based upon the reference template 70. Also, to the maximum print size, a paper size of a maximum printing template which can be produced by this reference template 70 is written. Limitations of these printing paper sizes can avoid not only such a case that an image quality of an image to be printed is considerably deteriorated, but also are required in view of copyright aspects.

Instead of the identifiers such as “A4” and “A3” representative of the ruled paper sizes, both longitudinal lengths and lateral lengths of papers as the size information may be alternatively written in the reference template. Also, paper sizes served as the size information may be alternatively described outside the reference templates in relation to the reference templates. Concretely speaking, for example, a table may be alternatively recorded in the reference template package file, while this table contains the identifiers of the respective reference templates in correspondence with the paper sizes. Also, the paper sizes may be alternatively defined in relation to the reference templates by employing a file which defines such a table irrespective of the reference template package file. Further, minimum resolution served as the restriction information may be previously determined in such a case that image files (for instance “fujisan”) functioning as an insertion object are inserted into image frames of print templates so as to be printed out. Concretely speaking, for instance, since such minimum resolution has been defined in a unification manner with respect to each of the image frames, or each of the reference templates, or in the technical specification, resolution in a case that an image to be inserted is inserted into an image frame after a reference template has been converted into a print template may be alternatively compared with the defined minimum resolution, and thus, a decision as to whether or not a resizing operation is allowed may be alternatively made based upon a comparison result. Alternatively, the minimum resolution may be indirectly defined by previously defining maximum sizes of either frames or images after resigning operations have been carried out. Alternatively, the minimum resolution may be directly defined by previously defining resolution.

Also, both a mark for indicating whether or not a resizing operation is allowed and a maximum print size as the restriction information may be alternatively described outside the reference template. For example, a field may be added to the above-explained table which contains the identifiers of the reference templates in relation to the paper sizes. This field indicates the mark for indicating whether or not the resizing operation is allowed and the maximum print size.

Further, the maximum print sizes served as the restriction information may be previously stored in the ROM of the control unit 15 in relation to the respective paper sizes which have been schemed to the reference templates as the technical specification. In other words, the restriction information is not defined every reference template, but the restriction information may be previously defined in a unification manner with respect to each of the paper sizes described in the reference templates.

FIG. 11 is a schematic diagram showing a process operation for executing printing operations in any sizes based upon one reference template, as a comparison example. A concrete example will now be explained as to a printing process operation based upon a reference template 90 of an A4 paper size. In a process operation for converting a reference template into a print template, both a fitting rule and an alignment rule of a drawing script of the reference template are directly employed as both a fitting rule and an alignment rule of a drawing script of the print template. An image frame coordinate of the print template is calculated by multiplying an image frame coordinate of the reference template by an enlarging ratio and a compression ratio respectively, which are determined by a ratio of a paper size of the reference template to a size of an actually printed paper. Since such a resizing process operation of the reference template is carried out, for instance, a print template 92 of an A5 size may be produced, a print template 93 of an A3 size may be produced, and a print template 94 of a postal card size may be produced from the reference template 90 of the A4 size. Also, in such a case that a printing operation is carried out in the paper size of the reference template, a print template 91 which directly employs the image frame coordinate of the reference template is produced. Next, since printing operations are carried out by inserting images 99 and 100 to be printed out into the image frames of the produced print templates, print results 95, 96, 97, and 98 are obtained. When print templates of various paper sizes are produced based upon a single reference template, as to the print templates 92 and 93 of the A3 size and the A5 size, the aspect ratios of which are analogous to the aspect ratio of the A4 paper size of the reference template, reproducing formats determined by arrangements of images and margins may become analogous to the reproducing format of the A4 paper size of the reference template 90. However, a producing format of the print template 94 of the postal card whose aspect ratio is not analogous to the aspect ratio of the A4 paper size of the reference template 90 does not become analogous to the reproducing format of the A4 paper size of the reference template 90, in which balances among right/left/upper/lower margins are different from each other.

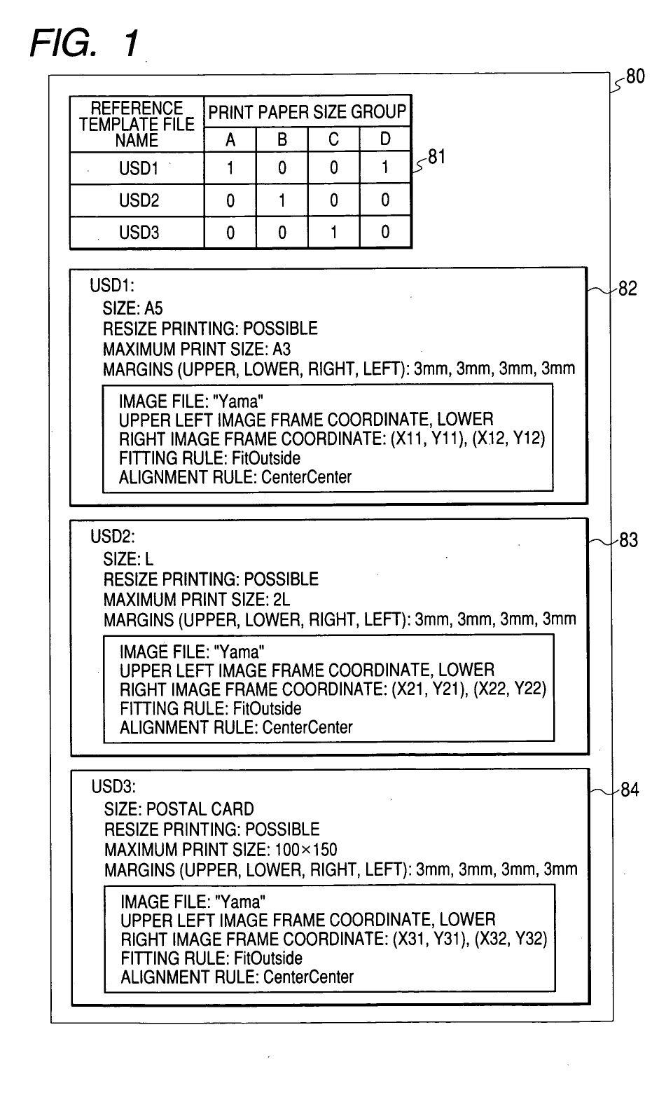

FIG. 1 is a schematic diagram showing a data structure of a reference template package file according to the first embodiment of the present invention. The reference template package 80 is stored in the ROM of the control unit 15 with respect to each of reproducing formats which are analogous to each other. The analogy of reproducing formats implies such a relationship that designs of reproduced results are analogous to each other except for dimensions of these designs, while these designs are determined based upon contents of images to be reproduced, arrangements of images, presence/absence of margins, balances among right/left/upper/lower margins, and the like. However, it should be understood that the implication of this analogy of the reproduced formats is different from mathematical similar figures. A plurality of reference templates 82, 83, and 84 which define image frame coordinates based on different print paper sizes one another are stored in the reference template package 80. The reference templates have respectively identifiers which are correspond to USD 1, USD 2 and USD 3 shown in FIG. 1 for identifying the specific reference template. Also, index data 81 is stored in this reference template package 80. This index data 81 defines that each of the reference templates 82, 83, 84 can be resized to a print template of which print paper size group. In the example shown in FIG. 1, a reference template “USD1” can be resized to both a print template of a printing paper size belonging to a printing paper size group “A” and a print template of a printing paper size belonging to a printing paper size group “D”.

The reference template package 80 may be alternatively entered into the printer 1 via either the removable memory 4 or an electric communication line. In a case that the reference template package 80 is entered from an external system to the printer 1, it is desirable to record the respective reference template data 82, 83, 84 as one file. This reason is given as follows: That is, while the relationship between the index data 81 and a plurality of reference template data 82, 83, 84, is maintained, portability when the reference template package 80 is inputted from the external system to the printer 1 may be improved. The reference template data 82, 83, 84 and the index data 81 may be alternatively recorded respectively as separate files. A printing paper size group corresponds to a group to which printing paper sizes belong whose aspect ratios are analogous to each other. For instance, AX, BX, and elongation sizes belong to a group “A”; L, and 2L belong to a group “B”; a postal card, 100×150 and 4×6 belong to a group “C”. The correspondence relationship between these printing paper sizes and printing paper size groups is stored in the ROM of the control unit 15 as a printing paper size group index. The correspondence relationship between the reference templates and the printing paper size groups is defined by the index data 81, whereas the correspondence relationship between the paper size groups and the printing paper sizes is defined by the printing paper size group index. Alternatively, the correspondence relationship between the reference templates and the printing paper sizes may be directly defined by the index data, for example, shown in FIG. 15.

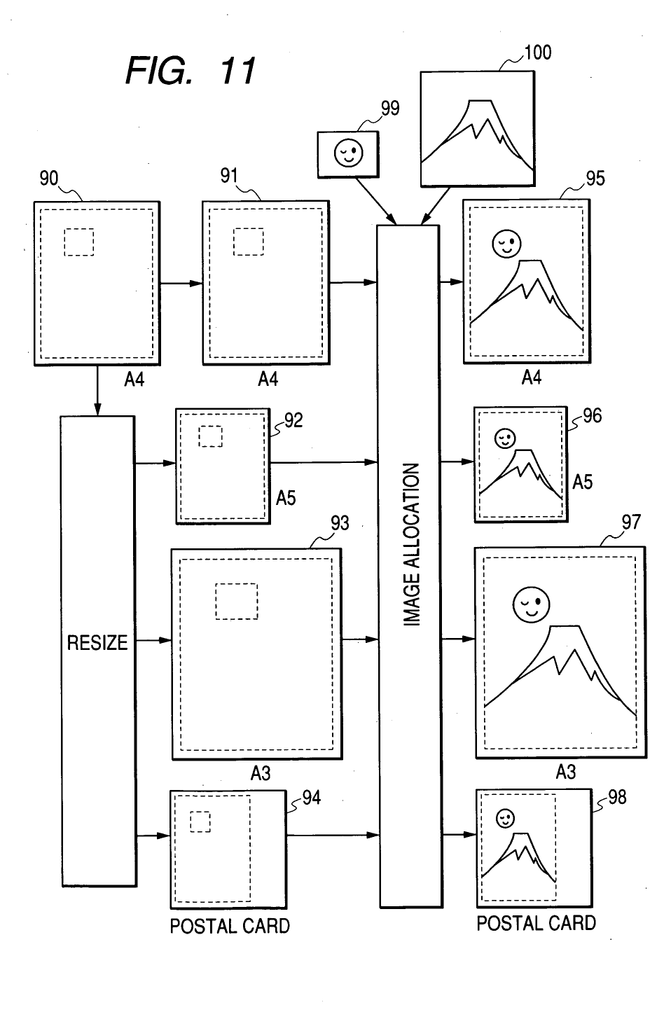

FIG. 12 is a data flow chart for showing a printing process operation with employment of a reference template package.

In a process 101, a reference template package file 102 which is selected by switching the jog key, or the like of the operation unit 13 is read from the ROM of the control unit 15. It should also be understood that the reference template package file 102 which is stored in the removable memory 4 may be selected by the user through the operation unit 13, and then, the selected reference template package file 102 may be alternatively read from the removable memory 4.

In a process 103, a printing paper size group to which a printing paper size set by switching the jog key, or the like of the operation unit 13 belongs is specified by referring to a printing paper size group index 104 which corresponds printing paper size groups to printing paper sizes. Furthermore, since index data of a reference template is referred, such a reference template corresponding to the specified printing paper size group is selected. Concretely speaking, when a printing paper size A5 is set by the user, the group “A” to which the printing paper size A5 belongs is specified by referring to the printing paper size group index 104. Next, a reference template file “USD1” is selected by referring to the index data 81 (see FIG. 1). Next, based upon the selected reference template file, such a message (signal) is outputted to a process 105, while this message instructs to produce a print template having a printing paper size which is set by a switching operation of a jog key, or the like of the operation unit 13.

In a process 103, in such a case that the set printing paper size is different from the paper size of the selected reference template, when the selected reference template defines that the resizing print operation is “not allowed”, when the set printing paper size exceeds the maximum print size defined by the reference template, or when there is no reference template which is related to the set printing paper size, such a message as “no printing operation is performed in this paper size” is displayed on the display 11.

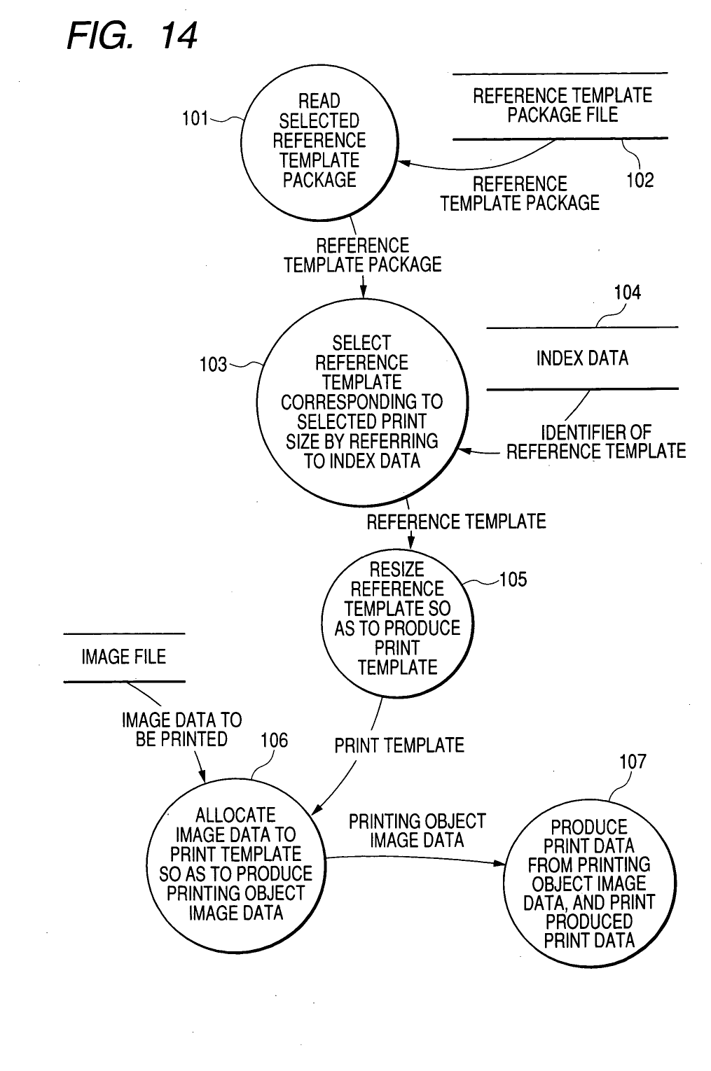

It should also be understood that the process 103 may be carried out in a manner as shown in FIG. 14. In the process 103 indicated in FIG. 14, a reference template corresponding to the paper size selected by executing the switching operation such as the jog key, or the like of the operation unit 13 is selected with reference to index data represented in FIG. 15. The index data shown in FIG. 15 is such information for defining paper sizes in correspondence with identifiers attached to reference templates. In other words, the respective paper sizes are defined in correspondence with the respective reference templates based upon both the paper sizes and the identifiers, which are described in the index data, and also, the identifiers attached to the respective reference templates.

Alternatively, both the process 101 and the process 103 may be carried out by an image processing system of a digital camera, or the like, or a personal computer (PC) connected to a printer. For example, both a setting operation of a printing paper size and a selecting operation of a reference template package file are accepted by the personal computer in which the reference template package files are stored in a hard disk, or a digital camera in which the reference template package files are stored in such a non-volatile memory as a flash memory. Then, a message may be alternatively outputted to a process 105 executed in the printer from the personal computer, or the digital camera. In this alternative case, the control apparatus for the printer of the digital camera, or the like, and the personal computer (PC) is served as the image processing system.

In a process 105, a print template of the printing paper size set by the user is produced based upon the reference template selected in the above-described process 103.

In a process 106, printing object image data is produced based upon the print template and the image data to be inserted.

In a process 107, print data is produced from the printing object image data, and this produced print data is outputted to a printer engine of the printer 1 so as to execute a printing operation. It should also be noted that the process 105, the process 106, and the generation of the print data may be alternatively executed by the personal computer, the digital camera, and the like, which are connected to the printer, in addition to both the process 101 and the process 103. Then, the print data may be outputted to the printer from the image processing system of the digital camera, and the personal computer (PC).

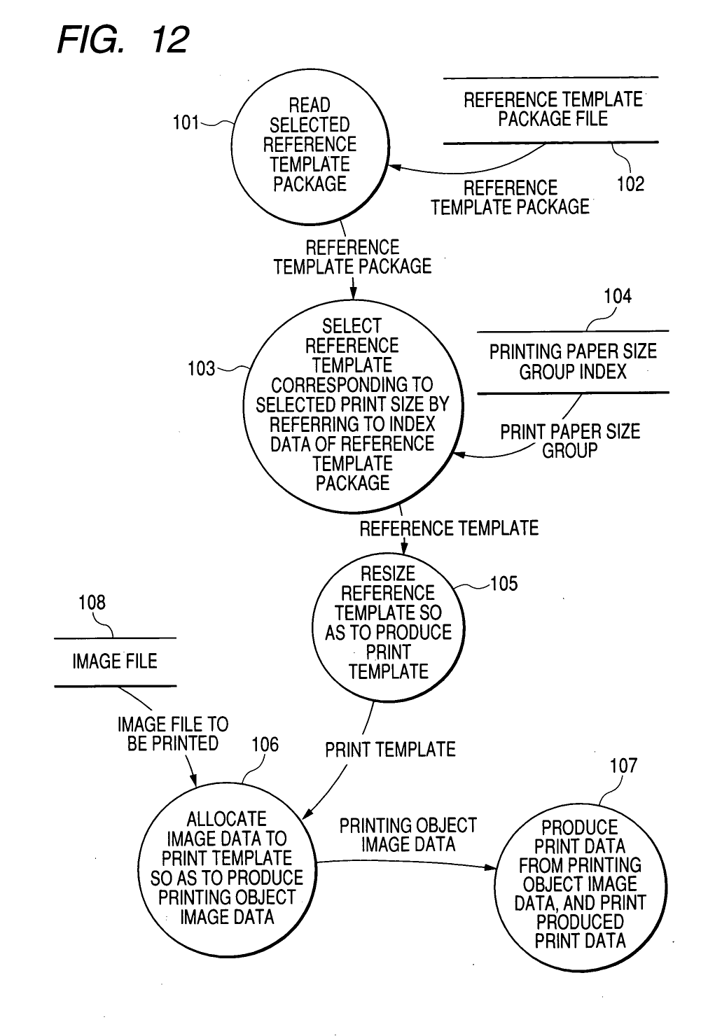

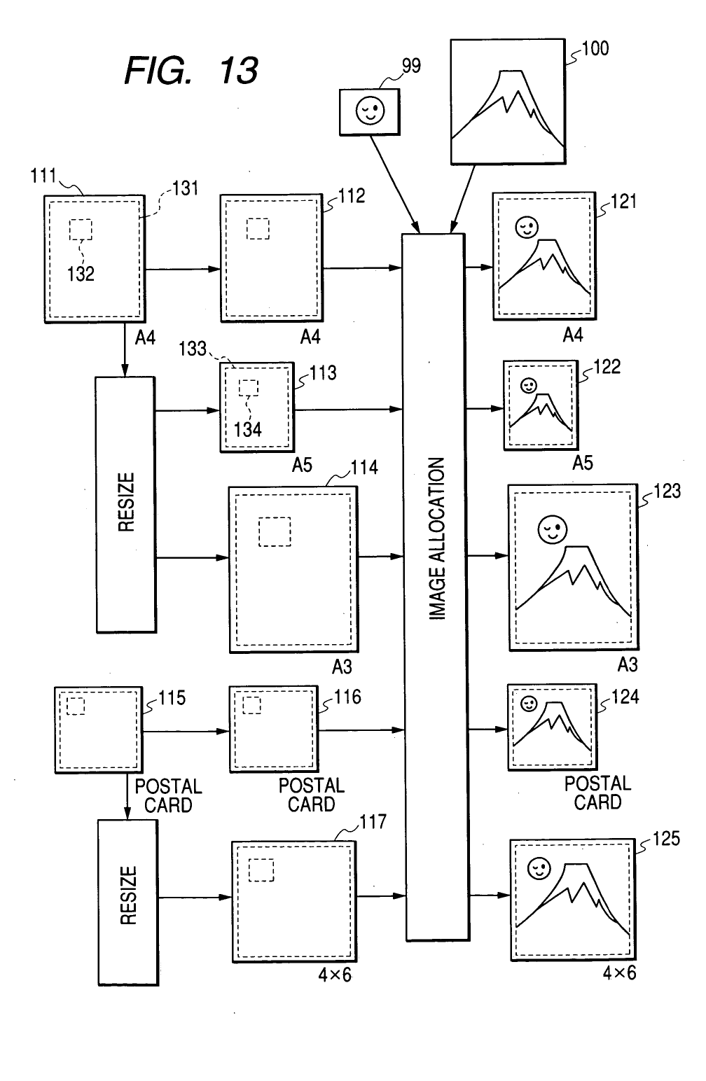

In accordance with the above first embodiment of the present invention, since the print data corresponding to a plurality of printing paper sizes is produced based upon one reference template, the total amount of the template data which define the reproducing format can be reduced. Also, the printing paper size group capable of printing the object by employing the respective reference template data is defined based upon the index data every reference template, so that the reproducing format can be defined based upon one piece of the reference template data as to the printing papers, the aspect ratios of which are made coincident with, or are approximated to each other. Also, as to other printing papers whose aspect ratios are not made coincident with, or are not approximated to each other, the separated reproducing formats can be defined by employing the coordinates which are different from each other based upon the reference templates which are different each other. That is to say, the total amount of template data can be reduced which are required so as to reproduce the objects such as the images on a large number of different sizes of printing papers by using the analogous layouts. This effect will now be explained with reference to an example of FIG. 13 as follows: That is, since two sets of an A4-sized reference template 111 and a 4×6 sized reference template 115 are previously stored with respect to 5 printing sizes belonging to both the printing paper size group “A” and the printing paper size group “C”, printed results 121, 122, 123, 124, and 125 which are analogous to each other can be obtained. Also, since the paper sizes which can be printed based upon the respective reference template data are defined by way of the index data 81 every reference template package in response to the design of the reproducing format, the total amount of the reference template data can be optimized every reference template package.

(Second Embodiment)

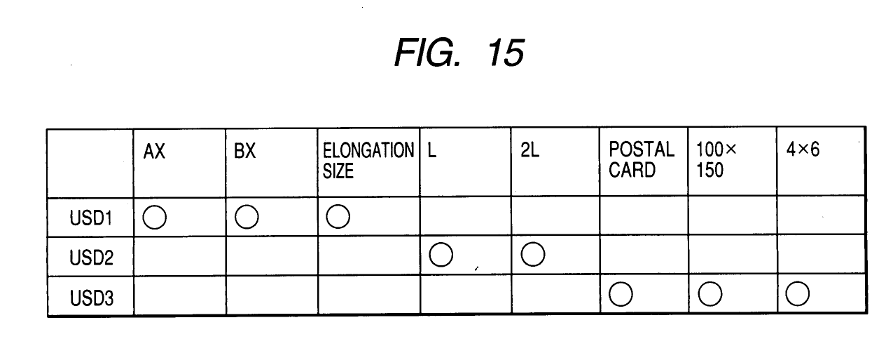

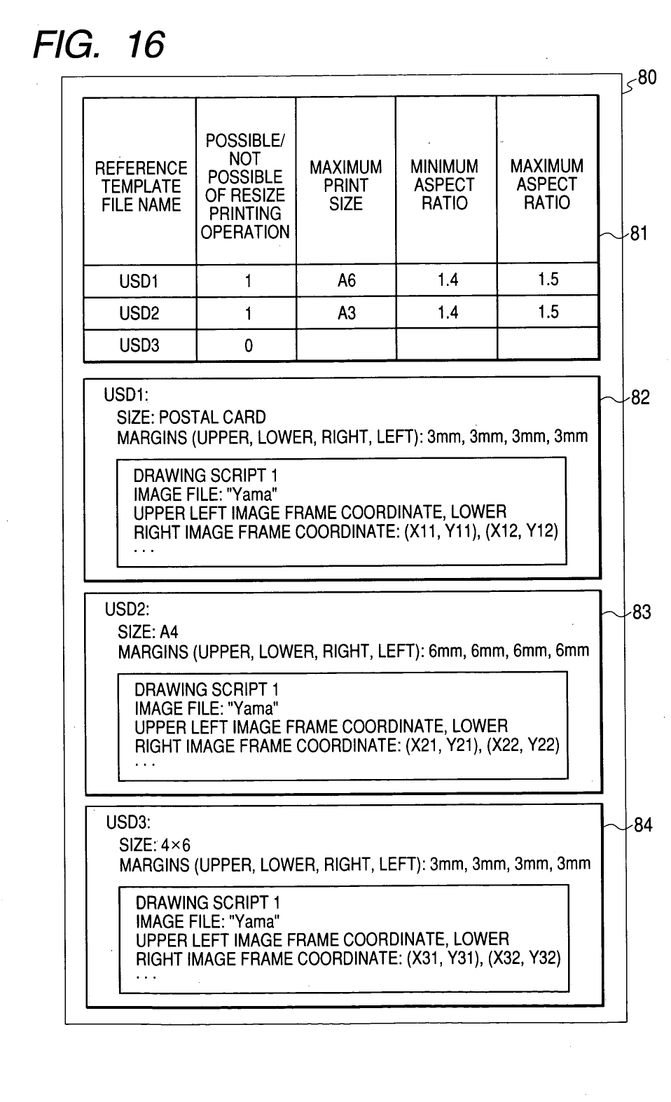

FIG. 16 is a schematic diagram for representing a data structure of a reference template package file as an embodiment of a template data structure according to the present invention. It should be understood that the same terminologies and the same reference numerals shown in the first embodiment will be employed as those for denoting the same, or similar elements of this embodiment.

A reference template package 80 corresponds to one file which contains index data 81; data indicative of reference templates 82, 83, 84; and data (for example, an image file whose file name is “Yama”) which indicates an image previously designated by a reference template. The index data 81 is stored as header information of the reference template package 80. Both the data indicative of the reference templates 82, 83, 84, and the data indicative of the image which are previously designated by the reference template correspond to such data that data which is originally present as individual files are stored into a single reference template package file by a predetermined application program.

The index data 81 of the reference template package 80 defines at least the below-mentioned items (1) to (4) every reference template:

(1) Information as to whether or not each of the reference templates can be resized to a size which is different from a printing paper size described in a script of this reference template (“possible/not possible of resize printing operation”).

(2) A maximum printing paper size at which each of the reference templates can be resized.

(3) A range of aspect ratios of printing papers on which the respective reference templates can be resized.

(4) An offset to each of the reference templates.

The above-described item (1) “possible/not possible of resize printing operation” served as the restriction information is defined by one bit data (flag). In the example shown in this drawing, it is so assumed that a flag “1” corresponds to “possible of resize printing operation”, and another flag “0” corresponds to “not possible of resize printing operation”.

The above-described item (3) “a range of aspect ratios of printing papers served as the restriction information on which the respective reference templates can be resized” is defined based upon both a minimum aspect ratio and a maximum aspect ratio. The respective reference templates may be interpreted as follows: Each of these reference templates can be resized based upon such an aspect ratio between a minimum aspect ratio and a maximum aspect ratio, which are defined as to the relevant reference template.

The above-described item (4) “offset (not shown) to each of the respective reference templates” defines an offset from a head of a reference template package file up to data indicative of a reference template.

A table 1 represents aspect ratios of the respective paper sizes. For instance, in the reference template package file 80 shown in FIG. 16, such a reference template “USD1” 82 that a script is described by setting a “postal card” size as a reference may be converted into a print template corresponding to both the printing paper size “A6” and the printing paper size “L”. Also, such a reference template “USD2” 83 that a script is described by setting a “A4” size as a reference may be converted into a print template corresponding to both the printing paper size “A4” and the printing paper size “A3”. Further, it is so prohibited that such a reference template “USD3” 84 that a script is described by setting a “4×6” size as a reference is converted into such a print template corresponding to a printing paper size not equal to “4×6”, since the resize printing operation is “not possible”.

TABLE 1

| printing paper size | lateral(mm) | longitudinal(mm) | aspect ratio |
|---|---|---|---|
| postal card | 1417 | 2097 | 1.48 |
| A6 | 1488 | 2097 | 1.41 |
| 4 × 6 | 1610 | 2485 | 1.54 |
| A4 | 2976 | 4209 | 1.41 |
| A3 | 4209 | 5952 | 1.41 |
| letter | 3060 | 3960 | 1.29 |
| L | 1260 | 1800 | 1.43 |

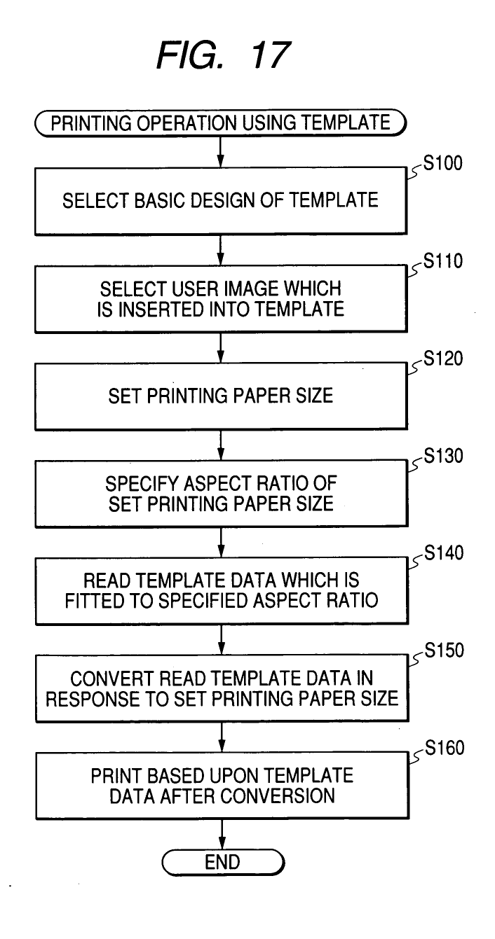

FIG. 17 is a flow chart showing process flow operations in which image data is printed by the printer 1 by employing the reference template package file according to the second embodiment.

First, a basic design of a template is selected by a user (step S100). For example, while image data indicative of the basic design of the reference template contained in the reference template package file is contained in this reference template package file, a list of images is displayed on the display 11 in combination with identifiers of respective files. These images represent basic designs of the plural reference template package files which are stored in either the removable memory 4 or the ROM of the control unit 15. Since any one of the identifiers is selected by operating the operation unit 13 by the user, one reference template package file is selected by the user. It should be noted that the “basic design” described in this concrete example implies such design elements which are commonly related to designs of the respective templates which are recognizable as mutually analogous designs except for slight differences in the designs due to differences of aspect ratios. These commonly used design elements are subjects of background images, positions with respect to printing papers of respective images, up/down relationships among layers of the respective images, and so on.

Next, an image (user image) which is inserted into the template is selected by the user (step S110). Concretely speaking, for instance, the user image which is inserted into the template is selected by the user in such a manner that an identifier (for example, file name, or serial number applied to each of user memories within system) of such a user image is selected by the user by operating the operation unit 13, and this user image is stored in the removable memory 4 every identifier (for example, “photograph 1”) described in a drawing script of a reference template contained in the selected reference template package file.

Next, a printing paper size is set by the user (step S120). Concretely speaking, for instance, the menu of the printing paper sizes is displayed on the display 11, and then, a specific printing paper size is selected by the operation unit 13. Next, an aspect ratio of the set printing paper size is specified (step S130). Concretely speaking, for example, while such a table for defining aspect ratios in correspondence with the respective printing paper sizes is previously stored in the ROM of the control unit 15, such an aspect ratio is read from the ROM, which is stored in correspondence with the set printing paper size.

Next, template data which is fitted to the specified aspect ratio is read (step S140). Concretely speaking, for instance, such a reference template which is fitted to this specified aspect ratio is specified by sequentially checking as to whether or not the specified aspect ratio is equal to such a value between the minimum aspect ratio and the maximum aspect ratio, which are described in the header of the presently-selected reference template package file, every reference template. Then, the reference template data is written in the work memory 16 based upon the offset described in the header of the reference template package file.

It should also be understood that the process operations defined from the step S100 to the step S140 may be alternatively processed by the personal computer (PC) connected to the printer, and the image processing system of the digital camera, or the like. Concretely speaking, for example, the personal computer (PC) and the digital camera, in which the reference template package files are stored in such a non-volatile memory as a hard disk or a flash memory, may alternatively output a message to the printer in such a manner that the user image selected in the step S110 is printed in the printing paper size set in the step S120 based upon the template data read in the step S140. In this alternative case, the control apparatus of the digital camera for printer, or the like, and the personal computer (PC) is served as the image processing system.

Next, the template data written in the work memory 16 is converted in response to the set printing paper size (step S150). Concretely speaking, for instance, as previously explained in the first embodiment, image frame coordinates of the respective drawing scripts are converted in response to the set printing paper, and then, a print template is formed.

Next, a printing operation is carried out based upon the template data after the converting operation (step S160). Concretely speaking, for example, as previously described in the first embodiment, printing object image data is formed based upon both the print template and the user image, and then, an image is printed on the printing paper having the set size based upon the printing object image data.

In accordance with the second embodiment, a flag is stored in the header in combination with the range of the aspect ratios of the reproduceable reproducing media, while this flag indicates as to whether or not the user image can be printed by employing the reference template data on the printing paper having the size except for such a size which is used as the reference of the reproducing format defined by this reference template data. As a result, the application ranges of the respective reference template data can be restricted. Also, the reference template data which is fitted to the printing paper size set by the user can be specified by merely referring to the header of the reference template package file, but not by referring to the reference template data.

Further, since the maximum print size every reference template is contained in the index data, as to such printing papers (namely, even when aspect ratios of these printing papers are made coincident with, or are analogous to each other, sizes of these printing papers are largely different from each other), the reference template data are individually prepared, and for instance, resolution of an image indicative of a background image can be changed every template in response to a size of a printing paper. More concretely speaking, for instance, in the drawing scripts corresponding to the reference template of “USD1” and the reference template of “USD2”, such image files which indicate the same object and whose resolution is different from each other may be designated in response to a maximum print size.

(Third Embodiment)

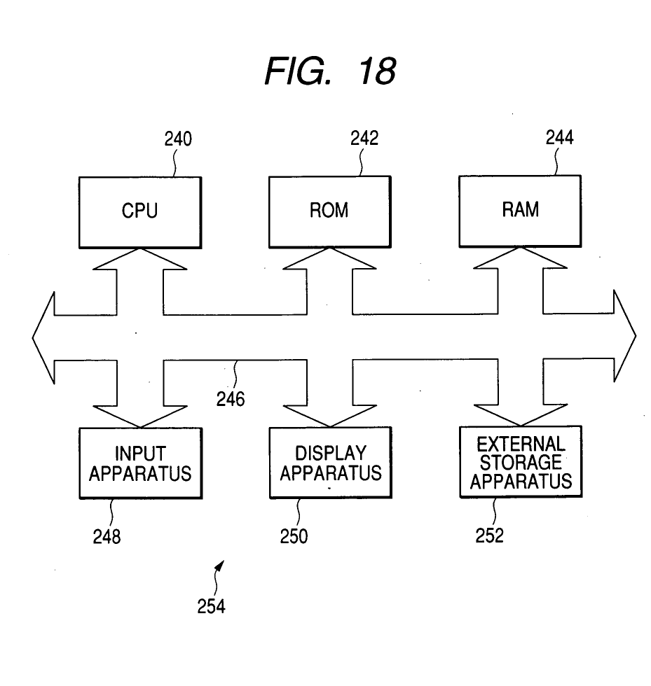

FIG. 18 is a block diagram showing a hardware structure of a template producing system 254 according to an embodiment of the present invention. The template producing system 254 has a CPU 240, a ROM 242, a RAM 244, an input apparatus 248, a display apparatus 250, and an external storage apparatus 252. These structural units are constituted by a personal computer which is mutually connected to these structural units via a bus 246. The CPU 240 executes programs which are stored in the ROM 242 and the external storage apparatus 252 so as to control an entire system of the template producing system 254. Also, since the CPU 240 executes a template producing program stored in the external storage apparatus 252, the personal computer may be served as a producing unit, a control information setting unit, and an output unit. The ROM 242 is such a memory which previously stores various sorts of programs and data therein. The RAM 244 is such a memory which temporarily stores various sorts of programs and data therein. The input apparatus 248 is arranged by a mouse, a keyboard, and the like. The input apparatus 248 is used so as to set a printing paper size, to set restriction information, to define a layout, and so on. The display apparatus 250 is constituted by a CRT, an LCD (Liquid Crystal Display), or the like. In the external storage apparatus 252, an operating system (OS), a template producing program, a reference template package file produced by the template producing program are stored in a hard disk, and the like. The template producing program may be alternatively downloaded from a predetermined server via a network to be entered in the template producing system 254, or may be alternatively read out from a computer-readable storage medium such as a removable memory and then may be entered thereinto.

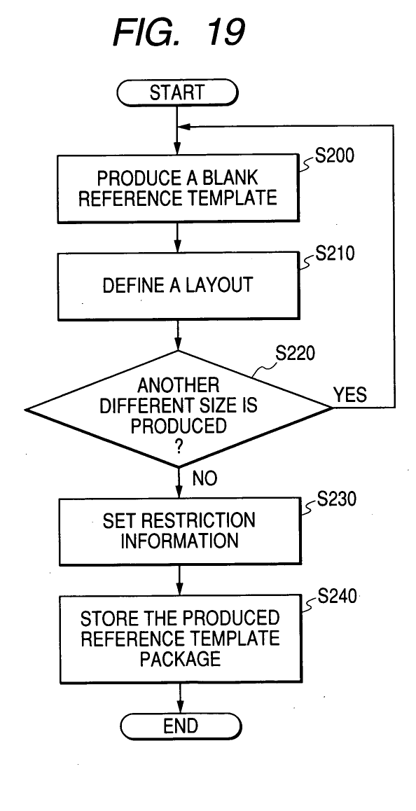

FIG. 19 is a flow chart showing process flow operations which output a reference template package file by employing the template producing program.

First, when a template forming process operation is selected from a predetermined upper-grade menu, the template producing system 254 produces a blank reference template in a paper size of default, and displays a cardboard corresponding to the paper size of default on the screen of the display apparatus 250 (step S200).

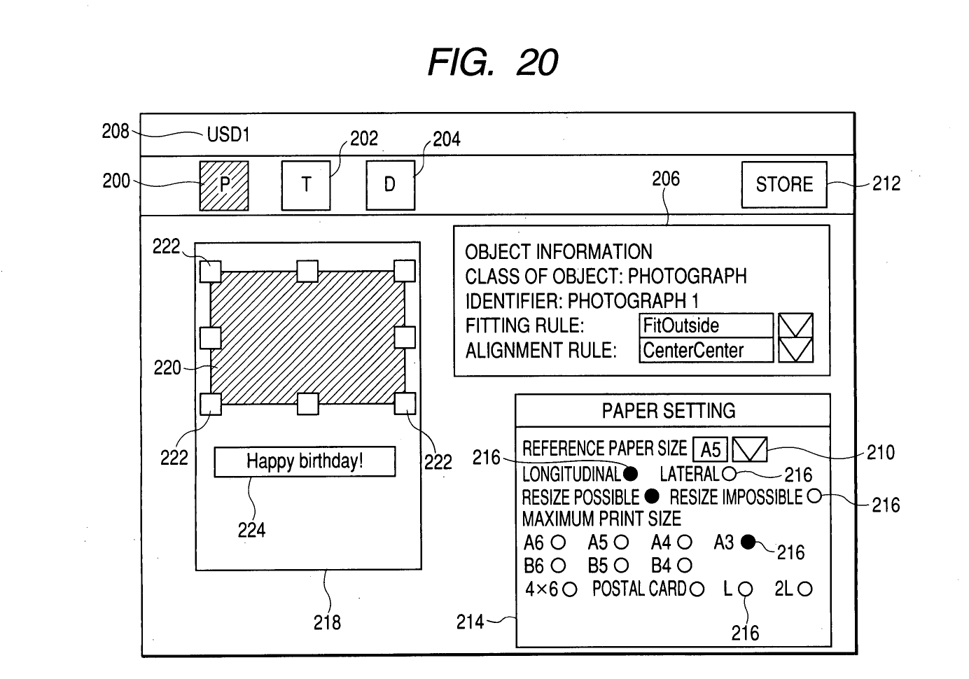

Next, the template producing system 254 accepts an editing operation of the reference template by the input apparatus 248, and defines a layout in response to the accepted editing operation (step S210). Concretely speaking, for instance, while the template producing system 254 displays such a window shown in FIG. 20 on the display apparatus 250, this template producing system 254 accepts the editing operation of the reference template. A concrete example of the editing process operation of the reference template will be explained in detail with reference to FIG. 20.

An identifier (for example, “USD1”) of a reference template to be edited is displayed on a title bar 208. The identifier of the reference template is automatically set every time the blank reference template is produced.

An image frame forming button 200 accepts an operation for setting an image frame. An image which will be inserted is selected by a file selection dialog, or the like, which are displayed when the image frame forming button 200 is selected. In the case that the image to be inserted is not selected, an identifier (for example, “photograph 1”) is automatically applied to an image frame which is newly defined. When the image frame forming button 200 is selected by a clicking operation, or the like, a rectangular area 220 may be designated on a cardboard 218 by a dragging operation. An image frame coordinate is set to the reference template in accordance with the rectangular area 220 which is designated on the screen.

A text frame forming button 202 accepts operation for defining both an area into which a character is inserted and the character to be inserted. When the text frame forming button 202 is selected by a clicking operation, or the like, a rectangular area 224 into which a text can be entered can be designated on the cardboard 218 by a dragging operation.

A drawing button 204 accepts an operation for arranging a figure such as a straight line and a curved line. When the drawing button 204 is selected, a toolbox (not shown) is displayed which contains buttons used to draw these figures on the cardboard 218.

An object information display area 206 corresponds to such an area which displays parameters of respective scripts defined in the reference template, which can be partially edited. A paper size setting area 214 corresponds to an area which represents a paper size of a reference template as size information, a mark for indicating whether or not a resizing operation is allowed as restriction information, and a maximum print size. Also, this area accepts setting operations of these size/restriction information and maximum print size. A button 210 accepts an operation for setting a paper size of a reference template. When the button 210 is selected, a drop down menu (not shown) is displayed in which selectable paper sizes are indicated, and then, an operation for changing a paper size can be accepted by a dragging operation. A plurality of radio buttons 216 accept operations for setting a paper direction, a condition as to whether or not a resizing operation is allowed, and a maximum print size. In response to ON/OFF state of each of the radio buttons 216, the paper direction, the condition as to whether or not the resizing operation is allowed, and the maximum print size are set to the reference template.

It should also be understood that the template producing system 254 may alternatively and automatically set the condition as to whether or not the resizing operation is allowed and the maximum print size as the restriction information in response to a paper size of a reference template set by a user.

A “store” button 212 accepts an operation for storing the reference template. When the “store” button 212 is selected by a clicking operation, the window for accepting the operation for editing the reference template is closed. As previously explained, the concrete example as to the editing process operation of the reference template has been described.

When the “store” button 212 is selected, the template producing system 25 inquires the user as to whether or not a reference template having another different size is produced (step S220). Concretely speaking, for example, a dialog window having a “OK” button and a “cancel” button is displayed on the display apparatus 250. When the process operation for producing the reference template having the different size from the above-described size is selected, the above-explained process operations defined in both the step S200 and the step S210 are repeatedly carried out.

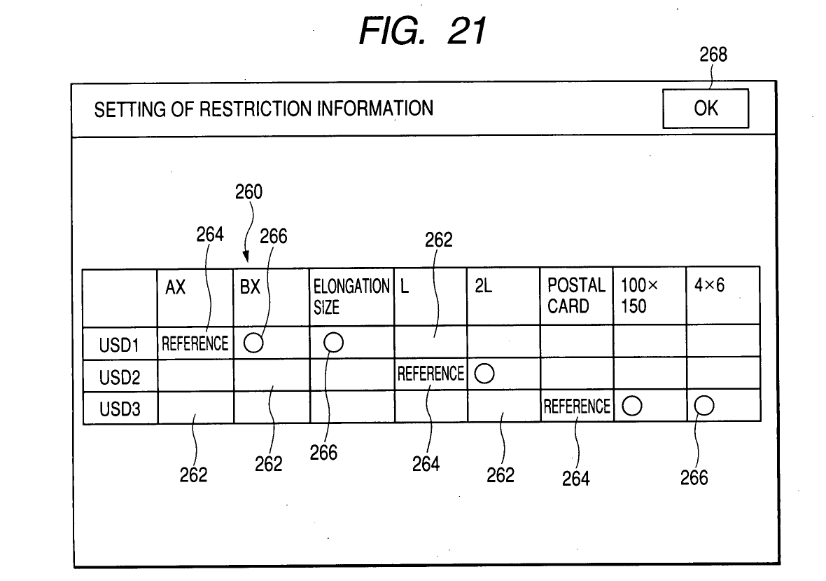

When a process operation for accomplishing the producing operation of the reference template is selected, the template producing system 254 accepts an operation for setting restriction information by the input apparatus 248, and then additionally sets the restriction information in response to the accepted setting operation (step S230). Concretely speaking, for example, a restriction information setting window shown in FIG. 21 is displayed on the display apparatus 250, and the index data which has been explained in the first embodiment and the second embodiment is produced. A concrete example as to the additional setting process operation of the restriction information will now be explained based upon FIG. 21.

A table 260 corresponding to the index data is displayed on the restriction information setting window. The restriction information of the reference template is displayed every row of the table 260, which can be edited. Either “reference” or “∘” is displayed on each cell of the table 260, or no indication is made on each cell. Such a cell on which “reference” is displayed represents that a layout of a reference template corresponding to a row of this cell has been defined, while a paper size corresponding to a column of this cell is used as the reference. The cell on which “reference” is displayed cannot be edited. When a cell of an blank column is clicked, symbol “∘” is displayed on this clicked cell. The reference template corresponding to a column of the cell on which symbol “∘” is displayed is set to such a condition that this reference template can be resized in a paper size corresponding to a column of this cell. A “OK” button 268 accepts an operation for producing index data. When the “OK” button 268 is selected by a clicking operation, the index data is produced in response to the setting content of the table 260. As previously explained, the concrete example as to the setting process operation of the restriction information is described.

It should also be understood that while the setting operation of the restriction information by the user is not accepted, for example, the restriction information may be alternatively set in accordance with the below-mentioned manner. That is to say, while such paper sizes which can be resized have been previously schemed every paper size on the technical specification, such an index data for setting a resizable paper size every paper size may be automatically produced by the template producing program 254 in accordance with the schemed technical specification.

When the “OK” button 268 is selected, the template producing system 254 produces a reference template package file, and then stores the produced reference template package file (step S240). Concretely speaking, for example, the template producing system 254 displays a dialog window on the display apparatus 250. The dialog window accepts an operation for setting both a storage location and a file name. When this template producing system 254 stores both one, or more sets of the produced reference templates and the index data into the set storage location as one file for a saving purpose.

In the template producing system 254 according to the third embodiment, the data (both maximum print size and resizable/not resizable condition) capable of controlling the resizing process operation of the template data is defined in relation to the reference template, and also, both the index data and the template data are produced in relation to each other, instead of such a process operation that the template data is produced every paper size. As a result, in this template producing system 254, a total data amount of such template data can be reduced, while these template data are required in order that the images and the texts are reproduced on the printing papers having the large numbers of paper sizes in the analogous layouts.

(Fourth Embodiment)

The fourth embodiment of the invention will now be described by reference to the accompanying drawings. It should be understood that a print condition file, a print condition setting script (a script) and a memory card shown in the fourth embodiment will be correspond to the reference template package file, the reference template (the print template), and the removable memory shown in the first, second and third embodiments of the invention.

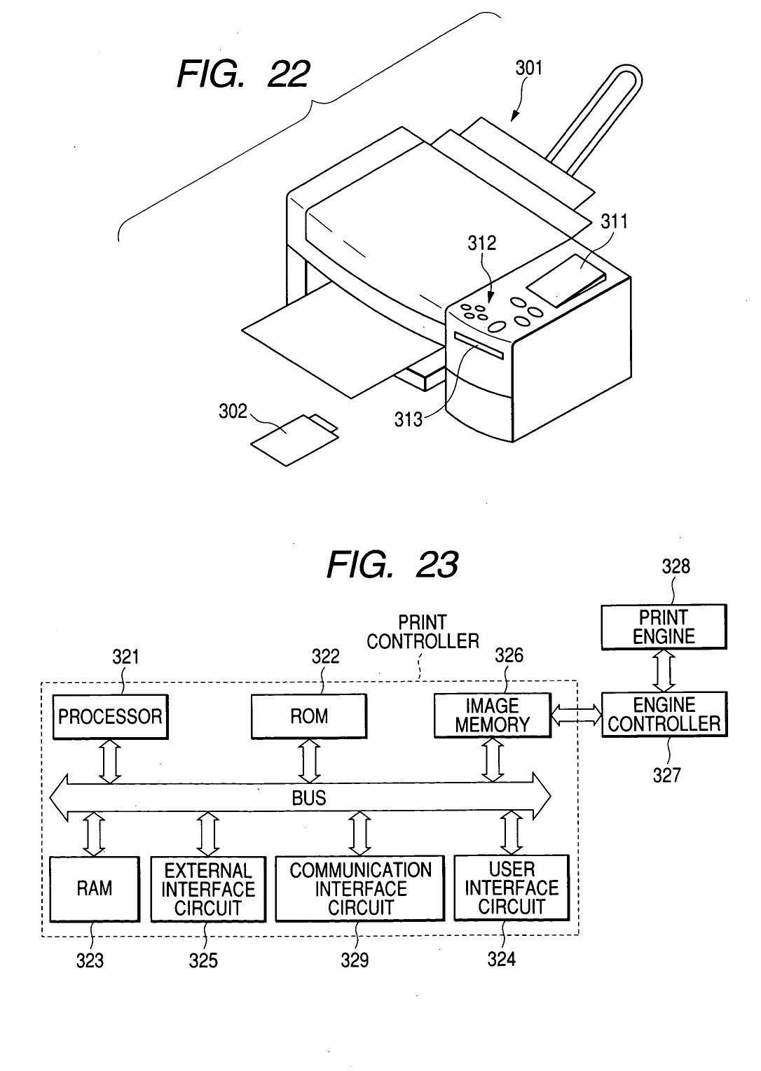

As shown in FIG. 22, a liquid crystal panel 311 and a plurality of buttons 312 are provided on the top face of a body of a printer 301 to form a user interface. In other words, a predetermined guidance message and so forth are displayed on the liquid crystal panel 311, so that a user is allowed to supply to the printer 301 print conditions and print instructions to be set interactively by pushing the buttons 312 in a manner corresponding to the contents displayed. Further a card slot 313 as an external interface is provided in the front body of the printer 301. The card slot 313 is in conformity with the PCMCIA standard and so arranged as to make replaceable a memory card 302 conforming to the standard.

Such a printer 301 is known as a stand-alone printer that need not be connected to a host computer. More specifically, the printer 301 displays a message on the liquid crystal panel 311 and awaits print instructions, the message urging the user to provide instructions about carrying out printing when the printer 301 detects the attachment of, for example, the memory card 302 into the card slot 313. Incidentally, the user is able to set the print conditions and provide the print instructions by pushing the buttons as occasion demands. Upon acceptance of the user's print instructions, the printer 301 reads image data stored in the memory card 302 and prints the data on printing paper. Thus, the user is able to utilize the printer 301 in such a manner as to directly print pictorial data deriving from a digital camera without the aid of the host computer.

However, such a stand-alone printer may be provided with any one of the interfaces including a parallel interface, a USB interface, a network interface or the like.

The memory card 302 incorporates a nonvolatile rewritable memory and is attached or detached with respect to the printer 301 and a digital camera. The user takes image data in the memory card 302 by taking photographs with the digital camera with the memory card 302 installed therein, and then takes out the memory card 302 from the digital camera and attaches the memory card 302 to the printer 301 for printing purposes. The image data thus taken in is stored in the memory card 302 in the form of files. Further, scripts for setting predetermined print conditions to the printer 301 (hereinafter, referred as “print-condition setting scripts”) have been stored in the memory card 302 beforehand.

In a case where the memory card 302 attached to the digital camera is a Compact Flash™ memory, for example, the memory is to be fitted into the card slot 313 of the printer 301 based on the PCMCIA standard via a PC card adaptor; however, this arrangement means to include the use of such a PC card adaptor in a broad meaning.

As shown in FIG. 23, a processor 321 executes various control programs stored in a ROM 322 while using a RAM 323 serving as a main storage and also performs integral control over the printer 301. In other words, the processor 321 allows the programs to be executed so that the printer 301 can performs the predetermined functions in cooperation with the hardware. According to this embodiment, the printer 301 implements at least the following functions including user interface, print-condition setting, script interpreting/executing, image generating and print-control. Further, the ROM 322 stores specification information that it supports, for example, monochromatic/color printing, paper sizes and so forth.

A user interface circuit 324 is a circuit for controlling the user interface attained via the liquid crystal panel 311 and the various buttons 312. An external interface circuit 325 allows the processor 321 to access the memory card 302 put into the card slot 313. When the memory card 302 is put into the card slot 313, the external interface circuit 325 requests the processor 321 for an interruption. On detecting the interruption, the processor 321 awaits an input of print-condition setting from the user. With the print-condition setting, the user is able to select print conditions prepared on the printer side via the user interface and also to select a desired print-condition setting file out of a plurality of print-condition setting files stored in the memory card 302. After the print-condition setting file is selected by the user via the user interface circuit 324, the processor 321 accepts the print instructions, interprets the selected print conditions (including the selection of print-condition setting script) and generates image data based on the pictorial data.

An image memory 326 is a memory for temporarily storing the image data thus generated. An engine controller 327 reads the image data stored in the image memory 326 while controlling the operation of a print engine 328 and supplies the image data to the print engine 328. The engine controller 327 is activated by the print command sent from the processor 321 as a trigger when print image data for a predetermined printing width is obtained in the image memory 326. The print engine 328 is constituted of, for example, a paper feed mechanism and a print head to perform printing on a printing medium such as paper. In this case, a specific kind of printer such as a laser or serial printer may be employed, if necessary, as the print engine 328.

A communication interface circuit 329 is for use in communicating with the host computer represented by a personal computer and various interfaces such as a parallel interface, a USB interface and a network interface is applicable thereto. Moreover, the communication interface circuit 329 is not limited to a personal computer but preferably able to communicate with any other peripheral equipment such as a digital camera provided with the data to be printed. There is a USB communication interface as such a communication interface.

As shown in FIG. 24, the memory card 302 stores an image data file and the print-condition setting file. Each file may be managed hierarchically. Print-condition setting script is typically and separately prepared/edited by the personal computer and stored in the memory card 302. Preferably, a plurality of print-condition setting scripts defining various print conditions are stored; however, there may be cases where only one print-condition setting script is stored and where no print-condition setting script is stored.

In FIG. 25, line numbers are added for the sake of convenience. As shown in this figure, the exemplary print-condition setting script essentially consists of header sections (lines 1 to 14) and page sections (lines 15 to 16). A command for designating a paper size of “3.5×5 inches” (so-called L size) is described on the 13th line of the header section.

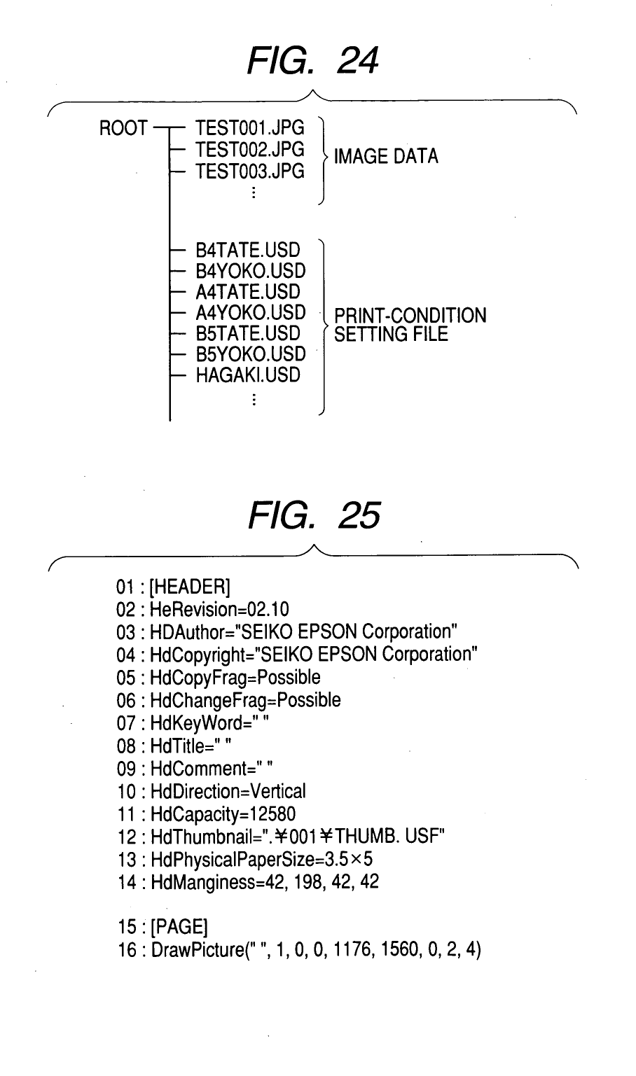

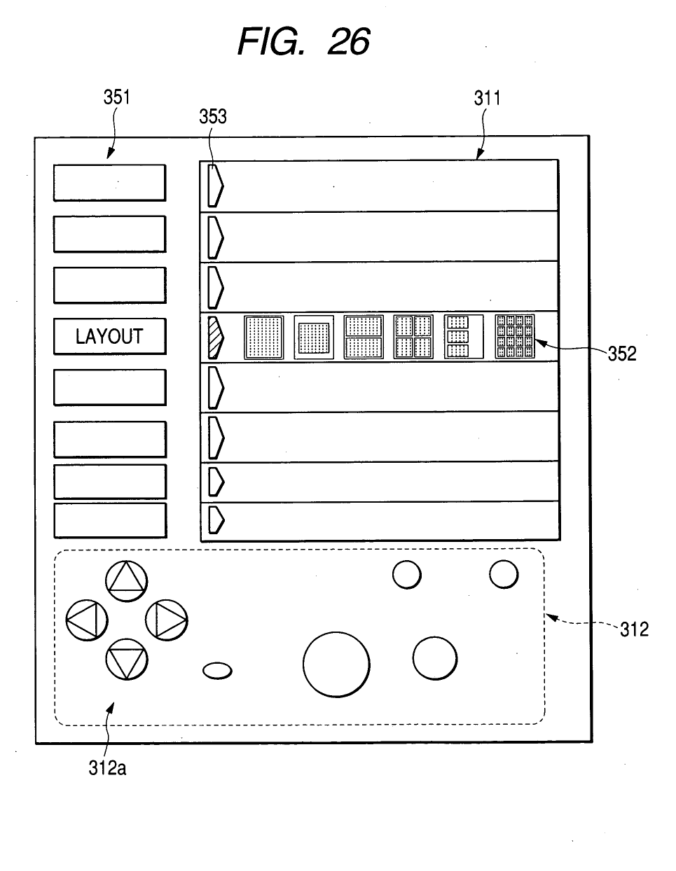

As shown in FIG. 26, the user interface essentially consists of the liquid crystal panel 311 and the various buttons 312. The liquid crystal panel 311 provides sub-items 352 in each item 351, including ‘print method,’ ‘kind of paper,’ ‘paper size’ and so forth. Although all sub-times 52 are shown in this figure, only the selected sub-items 352 are displayed during the operation. Various print conditions can be set to the printer 301 among the sub-items 352. In this case, though six kinds of sub-items are prepared for a ‘layout’ item beforehand, which are called ‘standard layouts,’ those which can be provided and utilized by the print-condition setting script are called ‘extended layouts.’

The item 351 subjected to the selection is indicated by a cursor pointer 353 (hatched one), the item 351 and the sub-item 352 being selected by pushing one of the left, right, up and down cursor buttons 312a. More specifically, the display of the cursor pointer 353 is moved in the corresponding direction when the user pushes the up or down cursor button, so that the user is informed of the item 351 subjected to the selection. While one of the items 351 is selected, the display of the sub-item 352 is moved in the corresponding direction when the user pushes the left or right cursor button, so that the user is informed of the sub-item 352 subjected to the selection. Through the above operation performed by the user, the values of print-condition parameters in conformity with the sub-items thus selected are set and reflected on the actual print conditions.

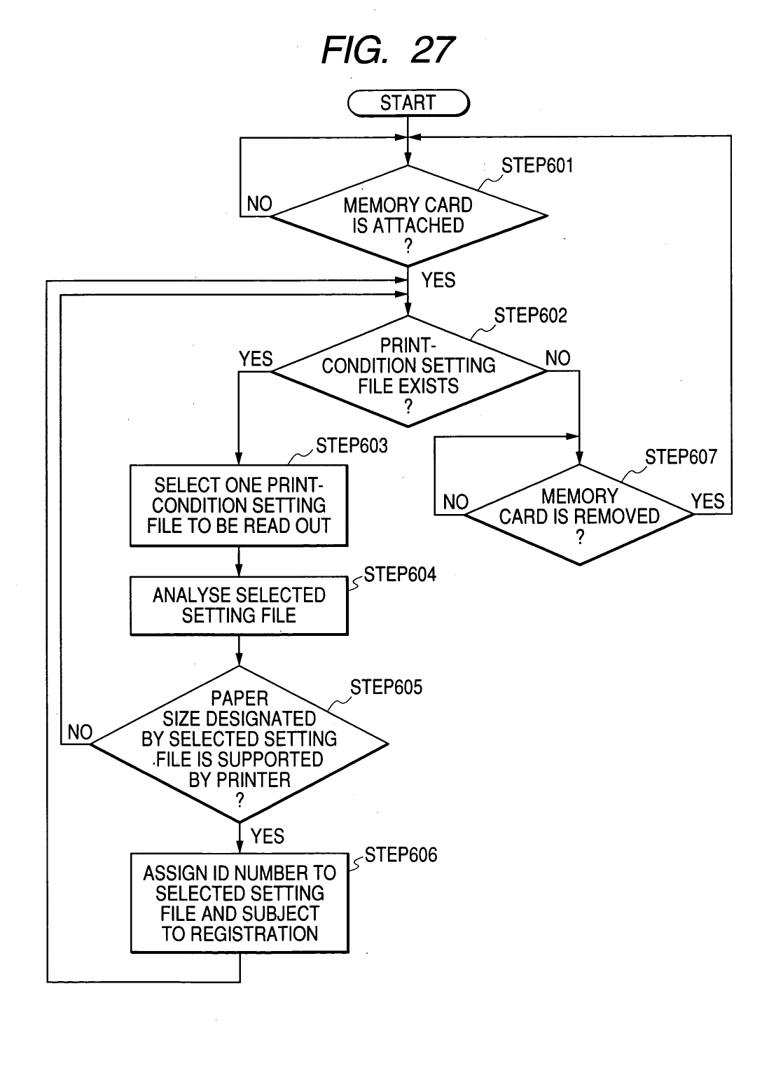

When the memory card is attached to the printer 301, the processing shown in FIG. 27 is performed by a memory card management program (module) and executed by the printer 301 in operation.

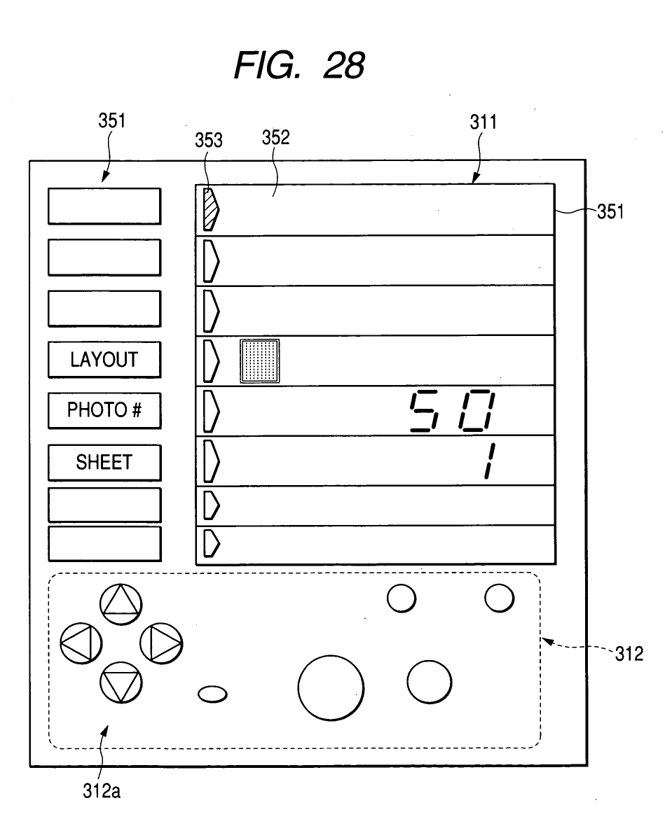

As shown in FIG. 27, the memory card management program is executed to monitor any interruption from the external interface circuit 325 (STEP 601). The interruption occurs when the memory card is attached to the card slot 313. On detecting the interruption, the memory card management program gains access to the memory card 302 and checks whether the print-condition setting file exists therein (STEP 602). Then the memory card management program checks the number of image data files stored in the memory card 302 and controls the external interface circuit 325 so that the set value of the present print-condition parameter is displayed on the liquid crystal panel 311. FIG. 28 shows an example of the user interface immediately after the memory card 302 is attached to the card slot 313. In the ‘layout’ item, ‘the whole page printing’ prepared as the standard layout has been selected in this example.

In a case where print-condition setting files are stored in the memory card 302, the memory card management program selects and reads one print-condition setting file via the external interface circuit 325 (STEP 603). The memory card management program subsequently analyzes the script representing the contents of the print-condition setting file (STEP 604) and checks whether the paper size designated by the setting file is the paper size that is supported by the printer (STEP 605). More specifically, the memory card management program refers to the value of “HdPhysicalPaperSize” described in the header section of the print-condition setting script. When the memory card management program decides that the script is consequently a supported script, the memory card management program registers the print-condition setting script in a predetermined area of the RAM 323 (STEP 606). In a case where the script designates “A3” size and where the printer does not support printing using the paper, for example, the script is not registered. When the script is registered, the memory card management program assigns an identification number to the print-condition setting script. The identification number is used to make the user identify the number over the user interface. The memory card management program performs the processing above with respect to all the print-condition setting files stored in the memory card 302 (STEPs 602-606). When the memory card management program finishes performing the processing above, the memory card management program remains to stand by until the memory card 302 is removed (STEP 607). When the memory card 302 is removed, the memory card management program returns to STEP 601 and monitors the entry of the memory card 302.

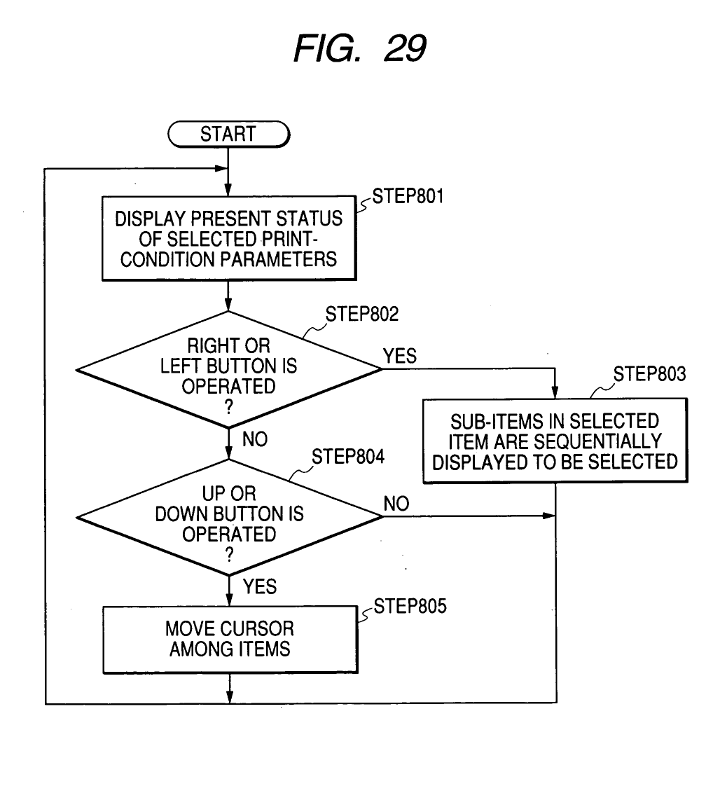

When the display/selection processing is performed in the user interface, processing shown in FIG. 29 is performed by, for example, a user interface program (module), and the printer 301 in operation executes this program.

As described above, the user interface program displays the contents of the present status of the selected print-condition parameter when the memory card 302 is attached to the card slot 313 (STEP 801; e.g., FIG. 28). The user is allowed to set print conditions by pushing the up, down, left and right cursor buttons 312a in this condition. When the user operates the left or right cursor button (Yes at STEP 802), the user interface program changes the display of the sub-item 352 in the item 351 sequentially (STEP 803). When a layout is selected, the processing of selecting the standard layout or an extended layout is performed as will be described later.

When user operates the up or down cursor button (Yes of STEP 804), on the other hand, the user interface program moves the cursor 353 among the items 351 (STEP 805).

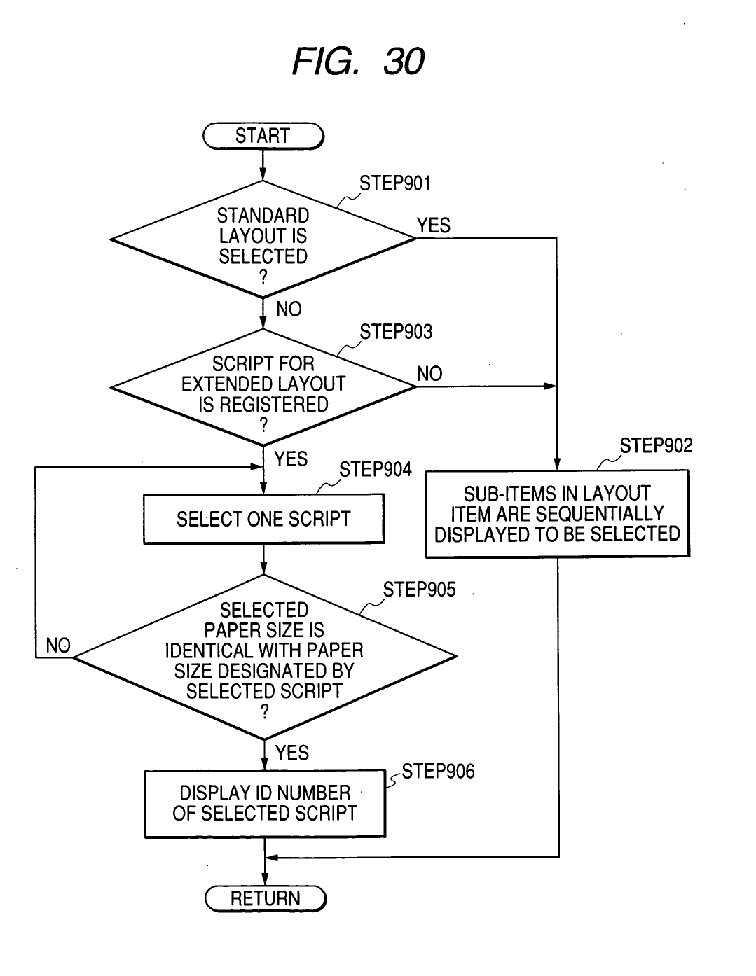

When the user pushes the left or right cursor button at the time the ‘layout’ item is selected, the processing shown in FIG. 30 is performed. The user interface program checks whether the user's operation is intended to set the standard layout or an extended layout (STEP 901). When the setting of the standard layout is requested, the user interface program causes the highlighted display to move to the sub-items 352 of the layout item, so that one parameter is to be selected (STEP 902).

When the setting of the standard layout is not requested, that is, when any sub-item other than the sub-items 352 at both ends is selected, on the other hand, the user interface program checks whether any script has been registered in a predetermined area in the RAM 323 (STEP 903). When the user interface program decides that no script has been registered, STEP 902 is followed because only the standard layout can be displayed/selected. In this case, the sub-item 352 on the opposite side is displayed such that it looks as if it returns to the first place. When the user interface program decides that there exists a script, on the other hand, the user interface program performs the following processing including displaying/selecting the extended layout.

In other words, the user interface program selects one registered script (STEP 904). Then the user interface program compares the paper size designated by the selected script with the paper size selected over the user interface and checks whether both the paper sizes conform to each other (STEP 905).

In a case where both the paper sizes do not conform to each other, the user interface program returns to STEP 904 and selects the next one script and does checking likewise. As only the paper size that the user interface program supports previously has been registered, the user interface program is able to finally select the conformed script by checking the paper sizes sequentially. When the paper size is decided to be in conformity with what is intended at STEP 904, the identification number attached to the script is displayed on the user interface (STEP 906). In a case where A4 size is selected over the user interface, for example, only a script designating a layout for A4 size out of those stored in the memory card 302 are sequentially displayed.

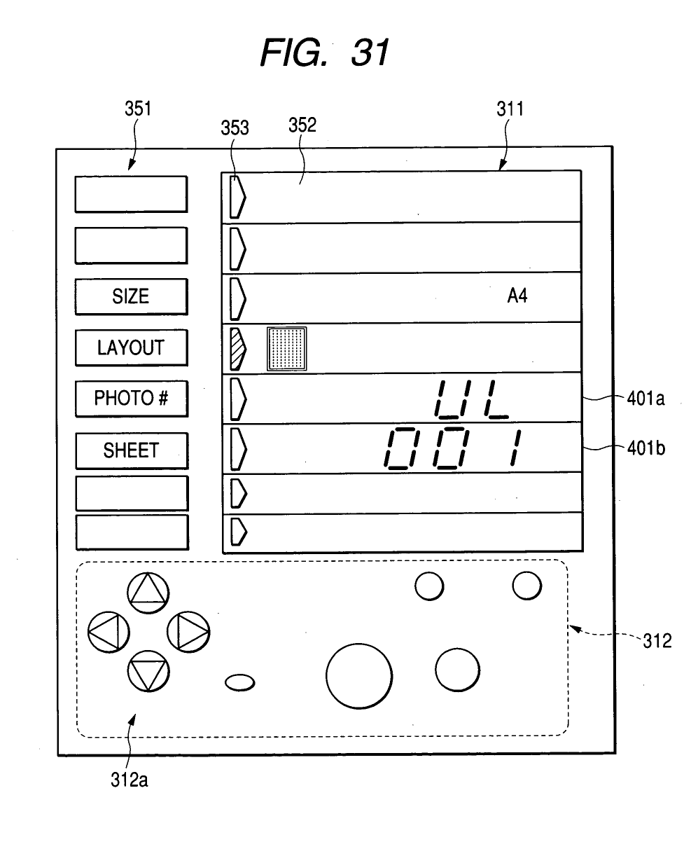

FIG. 31 shows an example of the user interface at this time. As shown in this figure, the display areas of ‘photo #’ (used for photo selection) and ‘sheet’ (used for designating printed number of sheet) of the items 351 are utilized respectively as display areas 401a and 401b for extended layouts. In other words, the diagram indicates a state in which “UL” as an extended layout display and a script with an assigned identification number “001” have been selected. When the user pushes the left (or right) cursor button in this state, the user interface program selects the script and displays its identification number at the same time.

In a case where the user pushes the up (or down) cursor button to move the cursor pointer 353 to ‘paper size’ of the item 351 first and selects an extended layout in ‘layout’ of the item 351 again after pushing the left (or right) button so as to select ‘post card’ of the sub-item 352, the user interface program performs the processing shown in FIG. 30 similarly. Then a script designating a layout for postcard size is displayed and the script for a postcard is displayed each time the left (or right) cursor button is pushed.

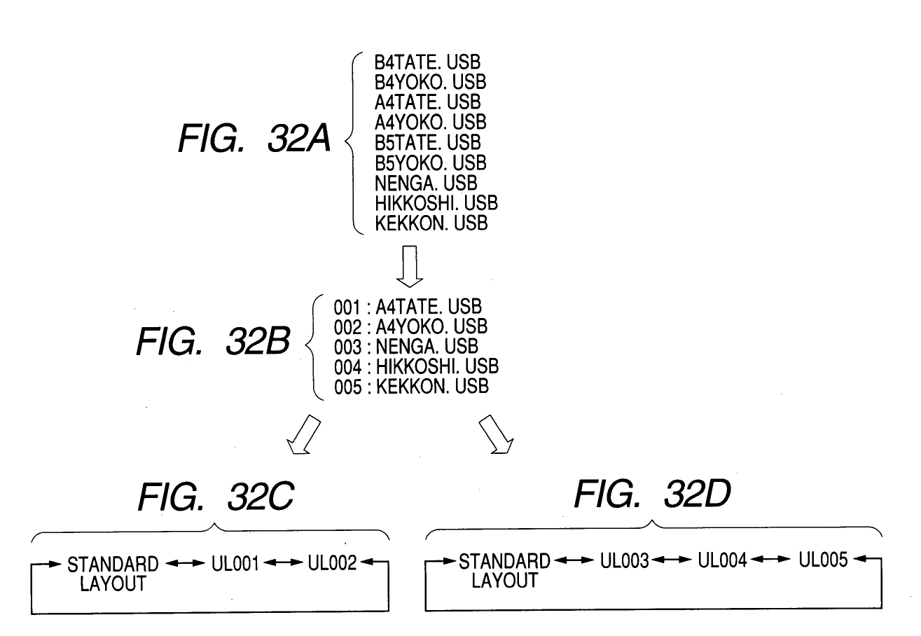

The operation of the printer 301 according to this embodiment of the invention will now be described by with reference to FIGS. 32A to 32D. As shown in FIG. 32A, there are nine print-condition setting files (scripts) to be stored in the memory card 302: namely, “B4TATE.USD” and “B4YOKO.USD” as scripts for defining layouts for B4 size; “B5TATE.USD” and “B5YOKO.USD” as scripts for defining layouts for B5 size; and “NENGA.USD,” “HIKKOSHI.USD” and “KEKKON.USD” as scripts for defining layouts for postcard size. In this case, the printer 301 is considered to support sizes of ‘roll paper,” A4’ and ‘postcard.’

When the user fits the memory card 302 into the card slot 313, the printer 301 reads in and interprets these print-condition setting files. Further, the printer 301 assigns identification numbers to the respective scripts for paper sizes that the printer 301 supports for the purpose of registration as shown in FIG. 32B. When the user selects not only the A4 paper size over the user interface but also the corresponding layout in this state, for example, switching of displays is made as shown in FIG. 32C, whereas when the user selects not only the postcard size but also the corresponding layout, switching of displays is made as shown in FIG. 32D.

The processing order may be changed in order or otherwise may be arranged in parallel order unless any inconsistency occurs in the operation.

According to this embodiment, paper sizes designated by print-condition setting files stored in a memory card is first checked, so that only scripts designating paper sizes supported by a printer is read out; and only scripts associated with paper sizes selected on a user interface are subsequently displayed as alternatives. Therefore, the user can easily select a desired script.

Further, as print-condition files designating extended layouts are stored in a memory card beforehand whereby to allow a printer to set print conditions accordingly, so that it is possible to provide a printer which is full of expandability and flexibility in view of setting print conditions.

Still further, extended layouts can be displayed/selected sequentially in the user interface provided with only necessary and sufficient functions to make the printer achieve the original display/selection objective of setting various print conditions.

In this embodiment, only script included in a print-condition setting file which designates a paper size supported by a printer is read out and registered. However, even though a paper size designated by a print-condition setting file is not exactly the same as a paper size supported by a printer, a script included in the print-condition setting file may be read out and registered if aspect ratios of these paper sizes are not so different.

Namely, when a printer supports a paper size of A4 size (JIS definition), a script included in a print-condition setting file which designates a paper size other than the A4 size may be read out if the paper size designated by the print-condition setting file is included in A-series or B-series in the JIS definition whose aspect rate is not so different from an aspect rate of A4 size.

What is claimed is:

1. An image processing system, comprising:
an operating unit, which select a first size of a reproducing medium;
a size information acquiring unit, which acquires size information related to a template for defining a layout of an object, the size information indicating a second size of a reproducing medium; and
a print control unit, which outputs an instruction for printing a predetermined object on the reproducing medium having the first size in accordance with the template,
wherein the first size is different from the second size indicated by the size information related to the template; and
wherein the aspect ratio of the reproducing medium having the first size is equal to, or approximates to that of the reproducing medium having the second size.

2. The image processing system as set forth in claim 1, wherein the template includes a script which defines a print layout.

3. An image processing system, comprising:
an operating unit, which select a first size of a print medium;
a printing medium size information acquiring unit, which acquires printing medium size information related to a script for defining a print layout, the printing medium size information indicating a second size of a print medium; and
a print control unit, which outputs an instruction for printing a predetermined object on the print medium having the first size in accordance with the script,
wherein the first size is different from the second size indicated by the size information related to the script; and
wherein the aspect ratio of the print medium having the first size is equal to, or approximates to that of the print medium having the second size.

4. An image processing system comprising:
a selecting unit, which selects a first size of a reproducing medium;
an acquiring unit, which acquires a template for defining a layout of an object on a template-related medium having a second size, the first size being different from the second size, and being substantially equal in aspect ratio to the second size;
an outputting unit, which outputs an instruction for arranging the object on the reproducing medium using the template for the template-related medium.

5. The image processing system according to claim 4, further comprising:
a restricting unit, which restricts available sizes of the template-related medium,
wherein the acquiring unit selects the second size of the template-related medium from the available sizes of the template-related medium, and acquires the template of the selected second size of the template-related medium.

6. The image processing system according to claim 5, wherein the restricting unit restricts the available sizes of the template-related medium based on a maximum size of the reproducing medium on which the object can be arranged using the template.

7. The image processing system according to claim 5, wherein the restricting unit restricts the available sizes of the template-related medium based on respective tolerable aspect ratio differences between the first size of the reproducing medium and the available sizes of the template-related medium.

8. The image processing system according to claim 4, wherein the acquiring unit selects and acquires the template of the template-related medium from a plurality of available templates, each defining a respective different layout of the object on the template-related medium.

9. An image processing method comprising the steps of:
selecting a first size of a reproducing medium;
acquiring a template for defining a layout of an object on a template-related medium having a second size, the first size being different from the second size, and being substantially equal in aspect ratio to the second size;
outputting an instruction for arranging the object on the reproducing medium using the template for the template-related medium.

10. A template producing system comprising:
a generating unit, which generates a template for defining a layout of an object on a template-related medium having a predetermined size;
a setting unit, which provides setting information for restricting a size of a producing medium, on which the object is to be arranged, using the generated template; and
an output unit, which outputs the generated template and the setting information.

11. A template data structure comprising:
a plurality of template data which define analogous formats for arranging an object on respective sizes of a template-related medium; and
a plurality of index data, each of which defines at least one size of a reproducing medium, on which the object can be arranged using a respective one of the template data.

12. The template data structure according to claim 11, wherein the template data and index data are stored as a single file.

13. The template data structure according to claim 11, wherein the template data includes parameter indicative of whether or not the object can be arranged on the reproducing medium having a first size different from a second size of the template-related medium by using the format for arranging the object on the second size of the template-related medium.

14. The template data structure according to claim 11, wherein the template data includes parameter indicative of a maximum size of the reproducing medium on which the object can be arranged by using each of the template data.

15. A template data structure comprising:
a plurality of template data which define analogous formats for arranging an object on respective sizes of a template-related medium; and
a plurality of index data, each of which defines a tolerable aspect ratio of a reproducing medium, on which the object can be arranged using a respective one of the template data.

16. The template data structure according to claim 15, wherein the template data and index data are stored as a single file.

17. The template data structure according to claim 15, wherein the index data includes parameter indicative of whether or not the object can be arranged on the reproducing medium having a first size different from a second size of the template-related medium by using the format for arranging the object on the second size of the template-related medium.

18. The template data structure according to claim 15, wherein the index data includes parameter indicative of a maximum size of the reproducing medium on which the object can be arranged by using each of the template data.

19. The image processing system according to claim 4, wherein the template includes a script which defines a print layout.
